(19) United States
(12) Patent Application Publication
(10) Pub. No.: US 2025/0259191 A1
(43) Pub. Date: Aug. 14, 2025

(54) METHODS AND SYSTEMS FOR DETERMINING OPTIMAL STORE LOCATIONS FOR AGGREGATE MERCHANTS

(71) Applicant: MASTERCARD INTERNATIONAL INCORPORATED, Purchase, NY (US)

(72) Inventors: Akash Choudhary, New Delhi (IN); Garima Arora, New Delhi (IN); Kanishk Goyal, Alwar (IN)

(21) Appl. No.: 19/050,514

(22) Filed: Feb. 11, 2025

(30) Foreign Application Priority Data
Feb. 12, 2024 (IN) 202441009344

(51) Int. Cl. G06Q 30/0202; G06Q 10/067

(52) U.S. Cl. CPC G06Q 30/0202; G06Q 10/067

(57) ABSTRACT

Methods and systems for determining optimal merchant store locations for aggregate merchants are disclosed. Method performed by server system includes accessing a transaction feature set, and a social media feature set for each merchant location from a database. Method includes labeling each merchant location with an active or inactive merchant flag and generating a geospatial merchant graph based on the corresponding transaction feature set, the corresponding social media feature set, and the corresponding label of each merchant location. Method includes computing, by a Siamese Machine Learning (ML) model, a merchant-specific embedding for each merchant location in the geospatial merchant graph. Method includes processing, by a Graph Neural Network (GNN) ML model, the geospatial merchant graph to rank each merchant location node and determining a set of optimal merchant locations from the plurality of merchant locations based on the corresponding rank of each merchant location node.

### TECHNICAL FIELD

The present disclosure relates to artificial intelligence-based processing systems and, more particularly, to electronic methods and complex processing systems for determining optimal store locations or optimal merchant store locations for aggregate merchants.

### BACKGROUND

With the growth in the retail sector, various retailers have shifted their focus to a multi-outlet model. The ‘multi-outlet model’ refers to a business model where a merchant (also, known as an ‘aggregate merchant’) opens multiple store locations across large geographical areas to broaden their market presence. The goal of this multi-outlet model is to increase accessibility for buyers or cardholders in all geographical locations so that the aggregate merchant can minimize the demand-supply gap. Examples of aggregate merchants following the multi-outlet model include Target®, Walmart®, Consumer Value Stores® (CVS), and the like. For successful implementation of the multi-outlet model, the locations of the merchant store sites must be chosen to maximize performance metrics that may vary with evolving consumer trends and aggregate merchant objectives.

As may be understood, selecting merchant store locations or sites, and benchmarking the performance of the selected merchant locations, is one of the most challenging tasks that aggregate merchants face in day-to-day operations. Generally, the site selection process depends on measuring performance on numerous financial metrics or aggregate merchant criteria such as revenue, brand value, fraud risk, etc. Thus, aggregate merchants need to make data-driven decisions to optimize their day-to-day store operations, digital rationalization needs, etc., for optimal cost and resource optimization.

To address these problems, various conventional techniques have been developed. One such technique involves using social media data, real estate data from governments, and other sources to recommend the opening of new stores and site selection. This technique aims to identify new potential locations for opening new stores and then analyze the projected performance based on some predefined criteria such as revenue or geographic coverage. The procedures for evaluating the performance of presently operating stores are governed by either established rules or an evaluated sentiment regarding the market attractiveness of the new area. However, this technique tends to yield biased or inaccurate results due to an excessive reliance on speculative assumptions.

Another conventional technique provides multi-criteria (such as business metrics like revenue, branding, fraud risk minimization, etc.) decision-making framework for monitoring the performance of a store location. However, this technique tends to oversimplify the local characteristics associated with the merchant stores, which are both high dimensional and unstructured. The limitation of other conventional techniques is that they tend to view the need for a merchant store from a consumer point of view while leaving the merchant side mostly unexplored.

To understand the problem from an aggregate merchant's point of view, it's imperative to understand the hierarchy of rules or criteria that an aggregate merchant deems important for its decision-making process on various metrics. Examples of such criteria include making decisions on the number of stores that are required for smooth operation for a merchant chain within a particular geography, how many stores per region are enough to meet the demands of the customers, improving the branding of stores by placement in prominent locations, targeting areas with low fraud risk, increasing customer base, lowering customer acquisition cost, and the like. All these criteria, when seen together, can give an objective view on how to answer the question of how many stores should continue to operate within a particular area, city, or even country. In other words, the main challenge is that these criteria are difficult to consider using a single data-driven approach or a single framework.

Thus, there exists a technological need for technical solutions for determining optimal merchant store locations for aggregate merchants.

### SUMMARY

Various embodiments of the present disclosure provide methods and systems for determining optimal merchant store locations for aggregate merchants.

In an embodiment, a computer-implemented method for determining optimal merchant store locations is disclosed. The computer-implemented method performed by a server system includes accessing a transaction feature set, and a social media feature set for each merchant location of a plurality of merchant locations associated with an aggregate merchant from a database associated with the server system. The computer-implemented method further includes labeling each merchant location with one of an active merchant flag or an inactive merchant flag based, at least in part, on the transaction feature set. The computer-implemented method further includes generating a geospatial merchant graph based, at least in part, on the corresponding transaction feature set, the corresponding social media feature set, and the corresponding label of each merchant location. The geospatial merchant graph includes a plurality of merchant location nodes corresponding to the plurality of merchant locations. Herein, a plurality of edges exist between the plurality of merchant location nodes, each edge indicating information related to a relationship between two distinct merchant location nodes in the geospatial merchant graph. The computer-implemented method further includes computing, by a Siamese Machine Learning (ML) model associated with the server system, a merchant-specific embedding for each merchant location in the geospatial merchant graph. The computer-implemented method further includes processing, by a Graph Neural Network (GNN) ML model associated with the server system, the geospatial merchant graph to rank each merchant location node of the geospatial merchant graph. The computer-implemented method further includes determining a set of optimal merchant locations from the plurality of merchant locations based, at least in part, on the corresponding rank of each merchant location node.

In another embodiment, a server system is disclosed. The server system includes a communication interface and a memory including executable instructions. The server system also includes a processor communicably coupled to the memory. The processor is configured to execute the instructions to cause the server system, at least in part, to access a transaction feature set, and a social media feature set for each merchant location of a plurality of merchant locations associated with an aggregate merchant from a database associated with the server system. Further, the server system is caused to label each merchant location with one of an active merchant flag or an inactive merchant flag based, at least in part, on the transaction feature set. Further, the server system is caused to generate a geospatial merchant graph based, at least in part, on the corresponding transaction feature set, the corresponding social media feature set, and the corresponding label of each merchant location. The geospatial merchant graph includes a plurality of merchant location nodes corresponding to the plurality of merchant locations. Herein, a plurality of edges exist between the plurality of merchant location nodes, each edge indicating information related to a relationship between two distinct merchant location nodes in the geospatial merchant graph. Further, the server system is caused to compute, by a Siamese Machine Learning (ML) model associated with the server system, a merchant-specific embedding for each merchant location in the geospatial merchant graph. Further, the server system is caused to process, by a Graph Neural Network (GNN) ML model associated with the server system, the geospatial merchant graph to rank each merchant location node of the geospatial merchant graph. Further, the server system is caused to determine a set of optimal merchant locations from the plurality of merchant locations based, at least in part, on the corresponding rank of each merchant location node.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a transaction feature set, and a social media feature set for each merchant location of a plurality of merchant locations associated with an aggregate merchant from a database associated with the server system. The method further includes labeling each merchant location with one of an active merchant flag or an inactive merchant flag based, at least in part, on the transaction feature set. The method further includes generating a geospatial merchant graph based, at least in part, on the corresponding transaction feature set, the corresponding social media feature set, and the corresponding label of each merchant location. The geospatial merchant graph includes a plurality of merchant location nodes corresponding to the plurality of merchant locations. Herein, a plurality of edges exist between the plurality of merchant location nodes, each edge indicating information related to a relationship between two distinct merchant location nodes in the geospatial merchant graph. The method further includes computing, by a Siamese Machine Learning (ML) model associated with the server system, a merchant-specific embedding for each merchant location in the geospatial merchant graph. The method further includes processing, by a Graph Neural Network (GNN) ML model associated with the server system, the geospatial merchant graph to rank each merchant location node of the geospatial merchant graph. The method further includes determining a set of optimal merchant locations from the plurality of merchant locations based, at least in part, on the corresponding rank of each merchant location node

### BRIEF DESCRIPTION OF THE FIGURES

For a more complete understanding of example embodiments of the present technology, reference is now made to the following descriptions taken in connection with the accompanying drawings in which:

FIG. 1 illustrates a representation of an environment related to at least some example embodiments of the present disclosure;

FIG. 2 illustrates a simplified block diagram of a server system, in accordance with an embodiment of the present disclosure;

FIG. 3 illustrates an exemplary representation of a geospatial merchant graph, in accordance with an embodiment of the present disclosure;

FIG. 4 illustrates an architecture of the framework for determining optimal merchant locations, in accordance with an embodiment of the present disclosure;

FIG. 5 illustrates a representation of various graphs for depicting the performance of four graph neural network models on community and single merchant benchmark mode or setting, with edges weighted by common cardholders or physical distance, in accordance with an embodiment of the present disclosure;

FIGS. 6A and 6B, collectively, illustrate a process flow diagram depicting a method for determining a set of optimal merchant locations from the plurality of merchant locations in a single benchmark merchant location mode, in accordance with an embodiment of the present disclosure;

FIGS. 7A and 7B, collectively, illustrate a process flow diagram depicting a method for determining a set of optimal merchant locations from the plurality of merchant locations in a community benchmark merchant location mode, in accordance with an embodiment of the present disclosure;

FIGS. 8A and 8B, collectively, illustrate a process flow diagram depicting a method for determining a set of optimal merchant locations from the plurality of merchant locations in an ideal benchmark merchant location mode, in accordance with an embodiment of the present disclosure;

FIG. 9 illustrates a process flow diagram depicting a method for determining a set of optimal candidate merchant locations from one or more candidate merchant locations, in accordance with an embodiment of the present disclosure;

FIG. 10 illustrates a process flow diagram depicting a method for determining a set of optimal merchant locations from the plurality of merchant locations, in accordance with an embodiment of the present disclosure;

FIG. 11 illustrates a simplified block diagram of an acquirer server, in accordance with an embodiment of the present disclosure;

FIG. 12 illustrates a simplified block diagram of an issuer server, in accordance with an embodiment of the present disclosure; and

FIG. 13 illustrates a simplified block diagram of a payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification does not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

The terms “account holder”, “user”, “cardholder”, “consumer”, and “buyer” arc used interchangeably throughout the description and refer to a person who has a payment account or a payment card (e.g., credit card, debit card, etc.) associated with the payment account, that will be used by a merchant to perform a payment transaction. The payment account may be opened via an issuing bank or an issuer server.

The term “merchant”, used throughout the description generally refers to a seller, a retailer, a purchase location, an organization, or any other entity that is in the business of selling goods or providing services, and it can refer to either a single business location or a chain of business locations of the same entity. The terms ‘merchant location’, ‘merchant site’, or ‘merchant store’, used throughout the description generally refer to physical brick-and-mortar stores operated by an individual aggregate or chain merchant.

The terms “payment network” and “card network” are used interchangeably throughout the description and refer to a network or collection of systems used for the transfer of funds through the use of cash substitutes. Payment networks may use a variety of different protocols and procedures to process the transfer of money for various types of transactions. Payment networks are companies that connect an issuing bank with an acquiring bank to facilitate online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc.

The term “payment card”, used throughout the description, refers to a physical or virtual card linked with a financial or payment account that may be presented to a merchant or any such facility to fund a financial transaction via the associated payment account. Examples of payment cards include, but are not limited to, debit cards, credit cards, prepaid cards, virtual payment numbers, virtual card numbers, forex cards, charge cards, e-wallet cards, and stored-value cards. A payment card may be a physical card that may be presented to the merchant for funding the payment. Alternatively, or additionally, the payment card may be embodied in the form of data stored in a user device, where the data is associated with a payment account such that the data can be used to process the financial transaction between the payment account and a merchant's financial account.

The term “payment account”, used throughout the description refers to a financial account that is used to fund a financial transaction. Examples of the financial account include, but are not limited to a savings account, a credit account, a checking account, and a virtual payment account. The financial account may be associated with an entity such as an individual, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction”, “financial transaction”, “event”, and “transaction” are used interchangeably throughout the description and refer to a transaction of payment of a certain amount being initiated by the cardholder. More specifically, refers to electronic financial transactions including, for example, online payment, payment at a terminal (e.g., Point of Sale (POS) terminal), and the like. Generally, a payment transaction is performed between two entities, such as a buyer and a seller. It is to be noted that a payment transaction is followed by a payment transfer of a transaction amount (i.e., monetary value) from one entity (e.g., issuing bank associated with the buyer) to another entity (e.g., acquiring bank associated with the seller), in exchange of any goods or services.

### Overview

Various embodiments of the present disclosure provide methods, systems, user devices, and computer program products for determining a set of optimal merchant locations for both existing and candidate merchant locations.

Although recent advances in deep learning allow the use of more powerful algorithms based on more data-driven approaches for site selection. Such approaches still fail to incorporate the spatial interaction patterns present within a physical map or geography.

The present disclosure overcomes this technical problem by providing an approach for understanding the relationship between the changing market trends through time while providing a data-driven solution that can help aggregate merchants rank and benchmark the performance of a particular store location against another store on various predefined metrics. In particular, the present disclosure provides a completely data-driven approach in the way that the server system analyses long-term market trends of the existing stores. The various embodiments of the present disclosure may be implemented using a system such as a server system. The server system is configured to understand the relationship between these trends and whether a particular merchant store should remain open or should be closed to save on cost.

As may be appreciated, graph-based models make use of Graph Convolution Layers (GCLs) that aggregate neighborhood information to learn node embeddings. The various embodiments of the present disclosure describe user-defined node embedding generation using a Siamese ML model and a Graph Neural Network (GNN) Machine Learning (ML) model for ranking store locations. An intelligent deep learning and graph-based system is provided that captures key indicators representative of major aggregate merchant criteria (such as revenue, fraud risk, branding, and the like) to create an embedding (i.e., a merchant-specific embedding) using the Siamese ML model. To generate this embedding an extensive list of transaction features and social media features is created depending on the aggregate merchant criteria for all the stores on a homogeneous merchant graph (i.e., a geospatial merchant graph).

In particular, the present disclosure introduces the concept of a benchmark merchant store (or benchmark merchant location) and an ideal merchant store (or ideal merchant location). The benchmark merchant location can be defined as per the month-on-month long-term highest performance within the homogeneous merchant graph (or at a community level within the graph). The ideal merchant location is an ideal static merchant location designed with high performance at a global scale. Then, using the Siamese ML model, a merchant-specific embedding for each merchant is extracted based on the similarity captured between the benchmark store and the corresponding merchant itself. It should be appreciated that since the Siamese ML model uses contrastive loss to generate merchant-specific embeddings, it is intuitive to understand that this embedding represents the similarity between a particular merchant in comparison to its benchmark store. Then, the merchant-specific embeddings extracted for the plurality of merchants are used as node embedding in the geospatial graph, i.e., the homogeneous merchant graph.

For processing the homogeneous merchant graph, a GNN ML model such as a Graph Classifier ML model is used. The graph classifier ML model is configured to predict scores and generate rankings for each node (representing an individual merchant/merchant store). These scores and ranks from the graph classifier ML model can then be used to facilitate the decision-making process of the aggregate merchant.

To that end, the present disclosure provides various technical effects to overcome the technical problems and limitations described earlier. In particular, an intelligent solution for ranking nodes in a homogeneous merchant graph, i.e., a geospatial graph, while accommodating the multiple aggregate merchant criteria and long-term trends of store operations.

More specifically, the various embodiments of the present disclosure provide multiple advantages and technical effects while addressing technical problems such as how to overcome the limitations of the existing frameworks and determining optimal locations for new merchant stores. Further, the present disclosure provides solutions for ranking existing merchant stores (i.e., the traditional brick-and-mortar stores) and providing relevant insights into the feasibility of such stores. Additionally, the various aspects enable the aggregate merchant to determine whether to close or scale back an existing associated merchant store based on these insights. Further, the present disclosure provides a solution for determining optimal merchant store locations while addressing the technical problems of a) changing customer demands, needs, and preferences, and b) changing aggregate merchant requirements and priorities.

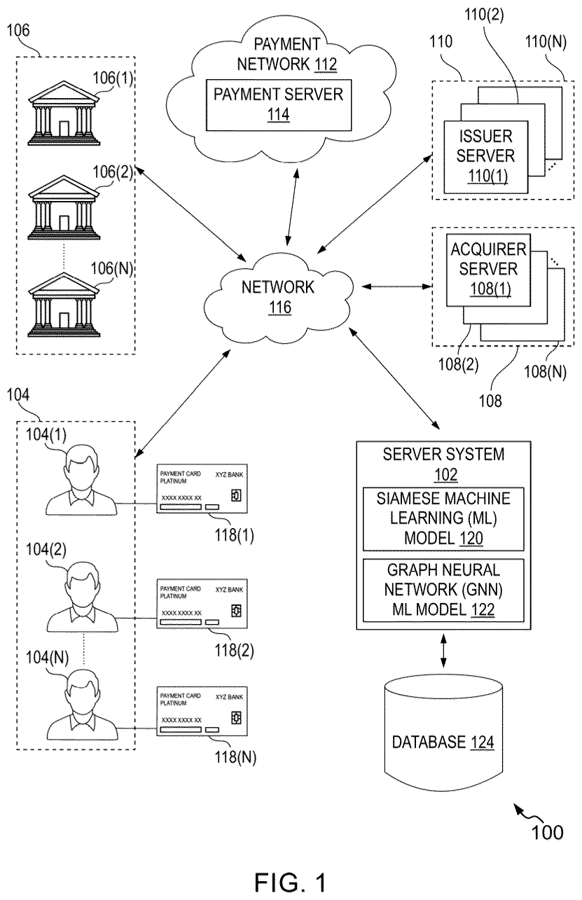

Various embodiments of the present disclosure are described hereinafter with reference to FIGS. 1 to 13.

FIG. 1 illustrates a representation of an environment 100 related to at least some embodiments of the present disclosure. Although the environment 100 is presented in one arrangement, other embodiments may include the parts of the environment 100 (or other parts) arranged otherwise depending on, for example, generating geospatial merchant graphs, determining embeddings of the nodes in the geospatial merchant graphs, determining a set of optimal merchant locations from a plurality of merchant locations, determining a set of optimal candidate merchant locations from a plurality of candidate merchant locations, and the like.

The environment 100 generally includes a plurality of entities such as a server system 102, a database 124 associated with the server system 102, a payment network 112 including a payment server 114, a plurality of cardholders 104(1), 104(2), . . . 104(N) (collectively, referred to as a plurality of cardholders 104 and ‘N’ is a Natural number), a plurality of merchant locations 106(1), 106(2), . . . , 106(N) corresponding to a plurality of merchants that belong to the same aggregate merchant (collectively, referred to as a plurality of merchant locations 106, merchant locations 106, or merchants 106, wherein ‘N’ is a Natural number), a plurality of acquirers 108(1), 108(2), . . . , 108(N) (collectively, referred to as a plurality of acquirers 108 and ‘N’ is a Natural number), a plurality of issuers 110(1), 110(2), . . . , 110(N) (collectively, referred to as a plurality of issuers 110 and ‘N’ is a Natural number), and each coupled to, and in communication with (and/or with access to) a network 116.

The network 116 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 116 in accordance with various wired and wireless communication protocols, such as Transmission Control Protocol/Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 116 may include multiple different networks, such as a private network made accessible by the server system 102 and a public network (e.g., the Internet, etc.) through which the server system 102, the plurality of acquirer servers 108, the plurality of issuer servers 110, and the payment server 114 may communicate.

In an embodiment, the plurality of cardholders 104 use one or more payment cards 118(1), 118(2), . . . 118(N) (collectively, referred to hereinafter as a plurality of payment cards 118 and ‘N’ is a Natural number) respectively to make payment transactions at the plurality of merchant locations 106. The cardholder (e.g., the cardholder 104(1)) may be any individual, representative of a corporate entity, a non-profit organization, or any other person that is presenting payment account details during an electronic payment transaction with a merchant (e.g., the merchant 106(1)). The cardholder (e.g., the cardholder 104(1)) may have a payment account issued by an issuing bank (not shown in figures) associated with an issuer server (e.g., issuer server 110(1)) from the plurality of the issuer servers 110 (explained later) and may be provided a payment card (e.g., the payment card 118(1)) with financial or other account information encoded onto the payment card (e.g., the payment card 118(1)) such that the cardholder (i.e., the cardholder 104(1)) may use the payment card 118(1) to initiate and complete a payment transaction using a bank account at the issuing bank.

In an example, the cardholders 104 may use their corresponding electronic devices (not shown in figures) to access a mobile application or a website associated with the issuing bank, or any third-party payment application. In various non-limiting examples, electronic devices may refer to any electronic devices such as, but not limited to, Personal Computers (PCs), tablet devices, Personal Digital Assistants (PDAs), voice-activated assistants, Virtual Reality (VR) devices, smartphones, and laptops.

In an embodiment, the plurality of merchant locations 106 refers to brick-and-mortar stores, i.e., physical store sites, owned or operated by the same aggregate merchant under the multi-outlet model. Such merchants may include retail shops, restaurants, supermarkets or establishments, government and/or private agencies, or any such places equipped with POS terminals, where consumers such as the plurality of cardholders 104 visit to perform financial transactions in exchange for any goods and/or services or any financial transactions.

In one scenario, the cardholders 104 may use their corresponding payment accounts or payment cards (e.g., the plurality of payment cards 118) to conduct payment transactions at the merchant locations 106. Moreover, it may be noted that each of the cardholders 104 may use their corresponding payment card from the plurality of payment cards 118 differently or make the payment transaction using different means of payment. For instance, the cardholder 104(1) may utilize the payment card 118(2) to perform an offline payment transaction at merchant location 106(1). It is understood that generally, the term “payment transaction” refers to an agreement that is carried out between a buyer and a seller to exchange goods or services in exchange for assets in the form of a payment (e.g., cash, fiat currency, digital asset, cryptographic currency, coins, tokens, etc.).

In one embodiment, the plurality of cardholders 104 is associated with the plurality of issuer servers 110. In one embodiment, an issuer server such as issuer server 110(1) is associated with a financial institution normally called an “issuer bank”, “issuing bank” or simply “issuer”, in which a cardholder (e.g., the cardholder 104(1)) may have the payment account, (which also issues a payment card, such as a credit card or a debit card), and provides microfinance banking services (e.g., payment transaction using credit/debit cards) for processing electronic payment transactions, to the cardholder (e.g., the cardholder 104(1)).

In an embodiment, the plurality of merchant locations 106 operated by aggregate merchants are generally associated with the plurality of acquirer servers 108. In an embodiment, each merchant or merchant location is associated with at least one acquirer server (e.g., the acquirer server 108(1)). In one embodiment, the acquirer server 108(1) is associated with a financial institution (e.g., a bank) that processes financial transactions for the merchant at different merchant locations 106. This can be an institution that facilitates the processing of payment transactions for physical stores (e.g., the merchant locations 106), or institutions that own platforms that make either online purchases or purchases made via software applications possible (e.g., shopping cart platform providers and in-app payment processing providers). The terms “acquirer”, “acquiring bank”, “acquiring bank” or “acquirer server” will be used interchangeably herein.

As explained earlier, merchant store location selection and recommendation are a well-known problem. To address this problem, various conventional techniques have been developed. One conventional technique focuses on finding new sites using empirical methods like sales forecasting techniques using regression, gravitational models, etc. These conventional approaches for making decisions on location selection for urban planning and brand expansion are not complex, and understanding the relationships between influential variables such as vicinity, neighborhood, and competitive variables in these approaches is fairly straightforward. These approaches were limited in their scope as the market was also less competitive and inflexible, unlike the case today.

With the boom of machine learning algorithms that have been developed since then, the problem of site selection and recommendation has become more and more complicated to solve using such simple conventional techniques. It is well established that for a lot of store brands-location is key in determining future cash flows, establishing a brand, and maintaining customer relationships. With time, the location selection problem has evolved into a multi-criteria problem of selecting new locations for placement of new stores, optimizing the existing stores, offline to online, and vice versa depending on changing market needs. Therefore, there is a need to establish a framework that can capture the changing market needs and long-term shopping trends among consumers or cardholders. There is also the need to incorporate the changing business or stakeholder objectives and help devise a framework that can optimize accordingly. Unfortunately, even today, these conventional techniques are limited in their scope and also have very limited access to open data sets that can be used for development and research due to data privacy and quality constraints.

Existing techniques that have been presented so far focus on different aspects of the location selection but with changing problem statements and focuses. Some works focus on approaching the problem with the idea of choosing a new location for the placement of a new store. Such works provide frameworks that use third-party data for locations and develop a methodology based on statistical methods like weighted sum and analytical hierarchy processes to derive insights for studying the performance of establishments. Another conventional approach tries to solve the store closure problem using gravity models. This conventional approach leverages customer patronization models to analyze the number of visits and footfall and how it will be affected after the closing of a store.

Yet another conventional technique presents an open dataset for testing site recommendation models' performances in a heterogeneous graph setting. Yet another approach utilizes OpenSiteRec, for generating location recommendations. This dataset encompasses data from four global metropolises from multiple sources and is extensive in its support for research. OpenSiteRec utilizes a diverse graph schema, employing entities to portray various real-world concepts such as categories, brands, Points Of Interest (POI), business areas, and regions. The relationships within the schema signify the associated commercial and geographical connections. Yet another conventional technique provides recommending store sites within the 020 model. This conventional technique utilizes a recommendation framework with multi-graph attention networks. This conventional technique considers factors such as courier capacity, customer preferences, and contextual features. However, none of these conventional techniques address the technical problems of a) changing customer demands, needs, and preferences, and b) changing aggregate merchant requirements and priorities.

The above-mentioned technical problems, among other problems, are addressed by one or more embodiments implemented by the server system 102 of the present disclosure. In one embodiment, the server system 102 is configured to perform one or more of the operations described herein.

In one embodiment, the environment 100 may further include the database 124 coupled with the server system 102. In an example, the server system 102 coupled with the database 124 is embodied within the payment server 114, however, in other examples, the server system 102 can be a standalone component (acting as a hub) connected to any of the acquirer servers 108 and/or issuer servers 110. The database 124 may be incorporated in the server system 102 or maybe an individual entity connected to the server system 102 or maybe a database stored in cloud storage. In one embodiment, the database 124 may store a Siamese Machine Learning (ML) model 120, a Graph Neural Network (GNN) ML model 122, a historical transaction dataset, a social media dataset, and other necessary machine instructions required for implementing the various functionalities of the server system 102 such as firmware data, operating system, and the like. In a particular non-limiting instance, the server system 102 may locally store the various ML models as well (as depicted in FIG. 1).

In an example, the database 124 stores the historical transaction dataset. The historical transaction dataset may include one or more transaction attributes related to a plurality of payment transactions performed between a plurality of cardholders 104 at a plurality of merchant locations 106 associated with an aggregate merchant. In some instances, the historical transaction dataset may also be called merchant-cardholder interaction data. The historical transaction dataset may include but is not limited to, one or more transaction attributes, such as transaction amount, source of funds such as bank or credit cards, transaction channel used for loading funds such as POS terminal or ATM, transaction velocity features such as count and transaction amount sent in the past ‘x’ number of days to a particular user, transaction location information, external data sources, merchant country, merchant Identifier (ID), cardholder ID, cardholder product, cardholder Permanent Account Number (PAN), Merchant Category Code (MCC), merchant location data or merchant co-ordinates, merchant name, city, zip code merchant industry, merchant super industry, ticket price or ticket size, number of unique cards, location, transaction channel (POS/Ecomm/Cash), product code and other transaction-related data. The historical transaction dataset enables the server system 102 to create a transaction business profile that identifies patterns in cardholder transactions that will assist the aggregate merchant in adapting to the changing consumer activity.

In an example, the database 124 stores the social media dataset. The social media dataset may include one or more social media attributes related to the plurality of merchant locations 106. In some instances, the social media dataset may also be called behavior/sentiment profile data. The social media dataset may include, but is not limited to, one or more social media attributes, such as online customer reviews, ratings, location, and timestamps from Social Media platforms (such as Twitter®, Yelp®, Zomato®, Facebook®, Instagram®, and the like), area data using Google®/Apple Maps®-address, area ratings, reviews, operating hours, traffic alerts and notifications (temporarily closed, etc.). The social media dataset enables the server system 102 to create a sentiment profile for each merchant location in a spatiotemporal setting by counting and clustering high-frequency words from the time-stamped and geo-tagged review data.

In another example, the Siamese ML model 120 may be an AI or an ML-based model that is configured or trained to generate merchant-specific embeddings for each merchant location from the merchant locations 106. In another example, the GNN ML model 122 may be an AI or an ML-based model that is configured or trained to process a homogeneous merchant graph or geospatial merchant graph to perform a classification task. It is noted that the various ML models have been explained in detail later in the present disclosure. In addition, the database 124 provides a storage location for data and/or metadata obtained from various operations performed by the server system 102.

In an embodiment, the server system 102 is configured to access the historical transaction dataset and the social media dataset from the database 124. Then, the server system 102 is configured to generate a transaction feature set, and a social media feature set for each merchant location of the merchant locations 106 based, at least in part, on, one or more transaction attributes and one or more social media attributes. Then, the server system 102 is configured to label each merchant location with one of an active merchant flag (indicating an open merchant location) or an inactive merchant flag (indicating a closed merchant store) based, at least in part, on the transaction feature set (and/or the social media feature set). In some instances, a self-supervised binary classification ML model may be utilized to label each merchant location.

Further, the server system 102 is configured to generate a geospatial merchant graph or a homogeneous merchant graph based, at least in part, on the corresponding transaction feature set, the corresponding social media feature set, and the corresponding label of each merchant location. In one implementation, the geospatial merchant graph includes a plurality of merchant location nodes corresponding to the plurality of merchant locations 106. Further, a plurality of edges exists between the plurality of merchant location nodes. It is noted that each edge indicates information related to a relationship between two distinct merchant location nodes in the geospatial merchant graph. For instance, information related to a relationship between two distinct merchant location nodes may be related to the geospatial distance between the physical locations of the merchants, the number of cardholders that performed transactions at both the merchants adjoined by an individual edge, and the like.

Thereafter, the server system 102 computes a merchant-specific embedding for each merchant location in the geospatial merchant graph based, at least in part, on, the corresponding transaction feature set, the corresponding social media feature set, and the benchmark/community benchmark/ideal merchant location. In a non-limiting example, the Siamese ML model 120 may be used to compute the merchants-specific embedding for each merchant. Further, the geospatial merchant graph is processed using the GNN ML model 122 to perform a classification task for scoring or ranking each merchant location node of the geospatial merchant graph. As may be appreciated, these ranked nodes can be analyzed based on the various internal policies or criteria of the aggregate merchant to generate a set or a list of optimal merchant locations from the merchant locations 106.

In one embodiment, the payment network 112 may be used by the payment card issuing authorities as a payment interchange network. Examples of the payment cards 118 include debit cards, credit cards, etc.

It should be understood that the server system 102 is a separate part of the environment 100, and may operate apart from (but still in communication with, for example, via the network 116) any third-party external servers (to access data to perform the various operations described herein). However, in other embodiments, the server system 102 may be incorporated, in whole or in part, into one or more parts of the environment 100.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 116, which may be specifically configured, via executable instructions, to perform steps as described herein, and/or embodied in at least one non-transitory computer-readable media.

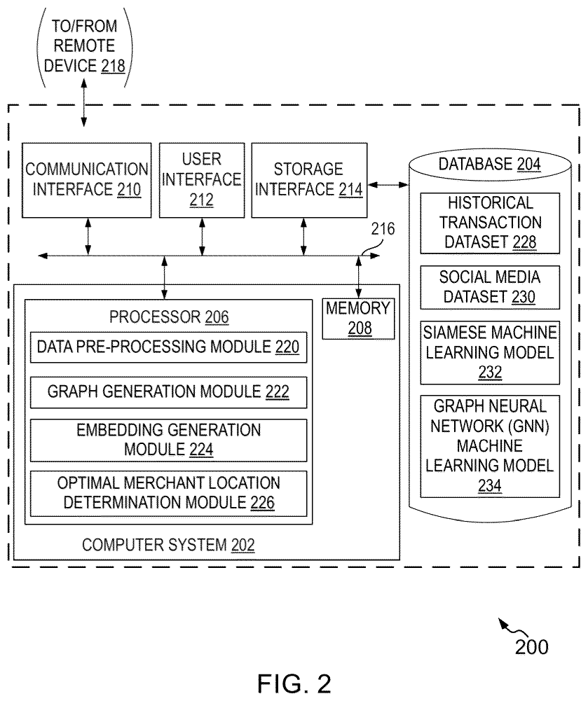

FIG. 2 illustrates a simplified block diagram of a server system 200, in accordance with an embodiment of the present disclosure. The server system 200 is identical to the server system 102 of FIG. 1. In one embodiment, the server system 200 is a part of the payment network 112 or integrated within the payment server 114. In some embodiments, the server system 200 is embodied as a cloud-based and/or Software as a Service (SaaS) based architecture.

The server system 200 includes a computer system 202 and a database 204. The database 204 is identical to the database 124 of FIG. 1. The computer system 202 includes at least one processor 206 for executing instructions, a memory 208, a communication interface 210, a user interface 212, and a storage interface 214 that communicates with each other via a bus 216.

In some embodiments, the database 204 is integrated into the computer system 202. For example, the computer system 202 may include one or more hard disk drives as the database 204. The user interface 212 is any component capable of providing an administrator (not shown) of the server system 200, the ability to interact with the server system 200. This user interface 212 may be a GUI or Human Machine Interface (HMI) that can be used by the administrator to configure the various operational parameters of the server system 200.

The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one non-limiting example, the database 204 is configured to store a historical transaction dataset 228, a social media dataset 230, a Siamese ML model 232, a GNN ML model 234, and the like. It is noted that the Siamese ML model 232, and the GNN ML model 234 are identical to the Siamese ML model 120, and the GNN ML model 122 of FIG. 1.

The processor 206 includes suitable logic, circuitry, and/or interfaces to execute operations for determining a set of optimal merchant locations from the plurality of merchant locations 106, determining a set of optimal candidate merchant locations from one or more candidate merchant locations, and the like. In other words, the processor 206 includes suitable logic, circuitry, and/or interfaces to execute operations for the machine learning model. Examples of the processor 206 include but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing the various operations described herein. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device (i.e., to/from a remote device 218) such as the plurality of issuer servers 110, the plurality of acquirer servers 108, the payment server 114, or communicating with any entity connected to the network 116 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 220, a graph generation module 222, an embedding generation module 224, and an optimal merchant location determination module 226. It should be noted that components, described herein, such as the data pre-processing module 220, the graph generation module 222, the embedding generation module 224, and the optimal merchant location determination module 226 can be configured in a variety of ways, including electronic circuitries, digital arithmetic, and logic blocks, and memory systems in combination with software, firmware, and embedded technologies.

In an embodiment, the data pre-processing module 220 includes suitable logic and/or interfaces for accessing the historical transaction dataset 228 and the social media dataset 230 from the database 204. In a non-limiting example, the historical transaction dataset 228 may include information related to a plurality of historical payment transactions performed within a predetermined interval of time (e.g., 6 months, 12 months, 24 months, etc.). In some other non-limiting examples, the historical transaction dataset 228 includes information related to at least merchant name identifier, unique merchant identifier, timestamp information (i.e., transaction date/time), geo-location related data (i.e., latitude and longitude of the cardholder/merchant), Merchant Category Code (MCC), merchant industry, merchant super industry, information related to payment instruments involved in the set of historical payment transactions, cardholder identifier, Permanent Account Number PAN), merchant name, country code, transaction identifier, transaction amount, and the like.

In one example, the historical transaction dataset 228 may define a relationship between each merchant location and the plurality of cardholders 104. In other words, a relationship between a cardholder account and a merchant store location may be defined by the historical transaction dataset 228. For instance, when a cardholder purchases an item from a merchant store, a relationship is said to be established.

In another embodiment, the historical transaction dataset 228 may include information related to past payment transactions such as transaction date, transaction time, gco-location of a transaction, transaction amount, transaction marker (e.g., fraudulent or non-fraudulent), and the like.

In a non-limiting example, the social media dataset 230 may include, but is not limited to, one or more social media attributes, such as online customer reviews, ratings, location, and timestamps from Social Media platforms (such as Twitter®, Yelp®, Zomato®, Facebook®, Instagram®, and the like), area data using Google®/Apple Maps®-address, area ratings, reviews, operating hours, traffic alerts and notifications (such as the store is temporarily closed, etc.).

In addition, the data pre-processing module 220 is configured to generate a transaction feature set for each merchant location of the plurality of merchant locations 106 based, at least in part, on, the one or more transaction attributes stored in the historical transaction dataset 228. Similarly, the data pre-processing module 220 is configured to generate a social media feature set for each merchant location of the plurality of merchant locations 106 based, at least in part, on the one or more social media attributes stored in the social media dataset 230. Further, the data pre-processing module 220 stores transaction feature set and the social media feature set in the database 204. In various non-limiting examples, the data pre-processing module 220 may utilize any feature generation approach to generate the transaction feature set and the social media feature set. It is understood that such feature generation techniques are already known in the art, therefore the same are not explained here for the sake of brevity. The feature generation process may be performed based on stakeholder or aggregate merchant focus-such as branding, low fraud, revenue, etc.

In certain scenarios, where one or more candidate merchant locations are to be introduced, feature generation can be performed by propagating features from its geographical neighbors. In a non-limiting example, one or more candidate merchant locations may be determined based on scoring areas based on social media dataset 230 and customer behavior activity to identify high-quality areas or zip codes in which new merchant locations can be opened. In particular, a sentiment profile is created which is a network structure generated by counting and clustering high-frequency words related to sentiment characteristics. A co-occurrence matrix that captures the semantic relationship between different words is clustered. This module evaluates the comprehensive sentiment strength of social media texts and generates a sentiment score for each candidate location (existing or prospective). In a non-limiting scenario, the sentiment profile may be derived from social media datasets, which include online reviews, ratings, and geo-tagged timestamps from platforms like Yelp®, Zomato®, Google Maps®, and so on. These profiles are created by clustering high-frequency words to assess comprehensive sentiment strength. They are instrumental in evaluating the market's emotional and behavioural tendencies. This insight aids merchants in identifying high-quality areas for business operations and optimizing store placements to align with consumer sentiment.

Further, the transaction behavior of the cardholders 104 is also analyzed. In particular, the data pre-processing module 220 provides a mechanism to identify hot spots within an area, city, province, etc., by leveraging the transactional activity of merchants. Further, the data pre-processing module 220 identifies patterns in consumer transaction behavior that will assist in adapting to the changing consumer activity, for example, opening stores in a new location. It is noted that the transaction behaviour captures patterns in cardholder's spending, such as transaction velocity, geographical hotspots, and consumer preferences. This data identifies key areas with significant transactional activity and helps anticipate demand shifts. Further, analyzing these patterns enables merchants to adapt their strategies, such as opening new stores in high-activity zones or modifying operational tactics to better serve consumers. By combining sentiment and transaction behavior, merchants can achieve a nuanced understanding of market trends and customer needs, thus optimizing resource allocation.

Then, the data pre-processing module 220 utilizes the sentiment profile and the transaction behavior to identify one or more candidate merchant locations where new merchant stores, i.e., perspective stores might be opened to significantly improve the performance of the merchant. These two aspects help to capture the changing trends in consumer transaction behavior along with consumer sentiment as well.

In another embodiment, the data pre-processing module 220 is communicably coupled to the graph generation module 222 and is configured to transmit the transaction feature set and the social media feature set for each merchant location of the plurality of merchant locations 106 to the graph generation module 222.

In an embodiment, the graph generation module 222 includes suitable logic and/or interfaces for labeling each merchant location with one of an active merchant flag or an inactive merchant flag based, at least in part, on the transaction feature set. The active merchant flag indicates that the corresponding merchant store is open for business and will continue to see transactions in the near future. On the other hand, the inactive merchant flag indicates that the corresponding merchant store is closed for business and will not see transactions in the near future. In a non-limiting example, a supervised classification ML model can be used for labeling the merchant locations 106. This aspect has been described in detail later in the present disclosure.

In another embodiment, the graph generation module 222 is configured to generate a geospatial merchant graph based, at least in part, on the corresponding transaction feature set, the corresponding social media feature set, and the corresponding label of each merchant location. In various non-limiting examples, the geospatial merchant graph includes a plurality of merchant location nodes corresponding to the merchant locations 106. These plurality of merchant location nodes are connected such that a plurality of edges exist between the plurality of merchant location nodes. Further, each edge indicates information related to a relationship between two distinct merchant location nodes in the geospatial merchant graph. This information may refer to the weights assigned to the edges. In some scenarios, this information may be the number of common cardholders that have transacted at the distinct merchants connected by an individual edge, the geographical distance between the merchant locations of the distinct merchants connected by an individual edge, and the like. In an example, the geospatial merchant graph is as merchant-merchant homogeneous graph.

In another embodiment, the graph generation module 222 is configured to access candidate merchant location information of one or more candidate merchant locations from the aggregate merchant. Here, the term ‘candidate merchant location’ refers to a potential location at which the aggregate merchant is considering to open a new merchant store. The candidate merchant location information includes one or more candidate merchant attributes for each candidate merchant. Then, the graph generation module 222 is configured to generate a plurality of candidate merchant location nodes based, at least in part, on the candidate merchant location information. Thereafter, the graph generation module 222 is configured to append a plurality of candidate merchant location nodes in the geospatial merchant graph based, at least in part, on the candidate merchant location information.

In another embodiment, the graph generation module 222 is communicably coupled to the embedding generation module 224 and is configured to transmit the geospatial merchant graph to the embedding generation module 224.

In an embodiment, the embedding generation module 224 includes suitable logic and/or interfaces for generating merchant-specific embedding for each merchant location in the geospatial merchant graph. More specifically, merchant-specific embedding can be generated using three different modes namely, (a) a single benchmark merchant location mode, (b) a community benchmark merchant location mode, and (c) an ideal benchmark merchant location mode.

In the single benchmark merchant location mode, the embedding generation module 224 is configured to generate a benchmark merchant location based, at least in part, on a plurality of aggregate merchant criteria. In an example, the aggregate merchant criteria may include fraud risk, revenue, operational cost, and the like. Further, the embedding generation module 224 is configured to compute, by the Siamese ML model 232, a merchant-specific embedding for each merchant location in the geospatial merchant graph based, at least in part, on the corresponding transaction feature set, the corresponding social media feature set, and the benchmark merchant location.

The Siamese ML model 232 is based on Siamese neural networks which are very effective for feature extraction, metric learning, few short learning, and feature tracking. The architecture of a Siamese ML model 232 is typically made of two identical parallel neural networks sharing the same weights and architecture. Each part of the neural network takes a separate feature vector as input, and the final prediction is made by combining their outputs. The primary objective of the Siamese ML model 232 is to make use of two identical base neural networks that take an actual feature vector and a candidate feature vector as inputs. Then, the Siamese ML model 232 learns a mapping function to produce similarity output between these two images/feature vectors. For learning this similarity function, various suitable loss functions may be used. In a non-limiting example, a contrastive loss function may be utilized by the Siamese ML model 232 for determining the similarity between the input feature vectors.

Contrastive loss, unlike other loss functions, requires a pair of input samples instead of single input samples. In other words, the main idea behind contrastive loss is to penalize the base network differently depending upon the classes of the input vectors/images. The contrastive loss function specifically causes the Siamese ML model 232 to create more similar feature embeddings for similar target classes and less similar feature embeddings for different target classes. Mathematically, contrastive loss is defined using the following exemplary equation:

$$Loss = ( 1 - Y ) \frac{1}{2} {( {D}_{W} )}^{2} + ( Y ) \frac{1}{2} {\{ max ( 0 , m - {D}_{W} ) \}}^{2} \qquad Eqn . 1$$

where y is the true label, and

$$y = \{ \begin{matrix}0 , when input vectors are similar \\ 1 , when input vectors are disimilar\end{matrix} \qquad Eqn . 2$$

D_{W} is the distance measure between feature embeddings of the input images.

As may be apparent, when, y=0, the loss contribution from identical pairs is reduced to the first term only, and D_{W} is minimized, whereas when y=1 then the loss will be reduced to the second term and D_{W} is maximized.

In the community benchmark merchant location mode, the embedding generation module 224 is configured to segregate the plurality of merchant locations into one or more communities using one or more community detection algorithms. Further, the embedding generation module 224 is configured to generate a community benchmark merchant location for each community of one or more communities based, at least in part, on a plurality of aggregate merchant community criteria. In an example, the aggregate merchant community criteria may include fraud risk, revenue, operational cost, and the like at the community level. Further, the embedding generation module 224 is configured to compute, by the Siamese ML model 232, a merchant-specific embedding for each merchant location present in an individual community within the geospatial merchant graph based, at least in part, on, the corresponding transaction feature set, the corresponding social media feature set, and the community benchmark merchant location.

In the ideal benchmark merchant location mode, the embedding generation module 224 is configured to generate an ideal merchant location based, at least in part, on a plurality of aggregate merchant ideal merchant criteria. In an example, the aggregate ideal merchant criteria may include fraud risk, revenue, operational cost, and the like for the ideal merchant at a global level. Further, the embedding generation module 224 is configured to compute, by the Siamese ML model 232, a merchant-specific embedding for each merchant location in the geospatial merchant graph based, at least in part, on the corresponding transaction feature set, the corresponding social media feature set, and the ideal merchant location.

Further, the embedding generation module 224 is configured to generate a candidate merchant embedding for each candidate merchant location node based, at least in part on, feature propagation from one or more merchant location nodes present in the neighborhood of each candidate merchant location node in the geospatial merchant graph.

In another embodiment, the embedding generation module 224 is communicably coupled to the optimal merchant location determination module 226 and is configured to transmit the merchant-specific embedding for each merchant location to the optimal merchant location determination module 226.

In an embodiment, the optimal merchant location determination module 226 includes suitable logic and/or interfaces for processing, by the GNN ML model 234, the geospatial merchant graph to rank each merchant location node of the geospatial merchant graph. It is noted that the GNN ML model 234 processes the graph structured data by learning node representations that encode both the node's features and its neighbor's relationships. It is particularly suited for geospatial merchant graphs where nodes represent merchant locations and edges capture relationships like shared customers or geographical proximity. The steps in the processing stage include (1) feature generation; (2) graph construction; (3) Message Passing and Aggregation; and (4) Node Scoring.

During feature generation stage, the transaction and social media datasets are pre-processed to create feature sets for each merchant location. Then, merchant-specific embeddings are computed using a Siamese ML model 232 by comparing merchant features with a benchmark or community benchmark store.

During graph construction stage, a geospatial merchant graph is built where nodes represent merchant locations and edges denote relationships such as the number of common cardholders or distances.

During message passing and aggregation stage, GNN layers aggregate neighborhood information iteratively for each node. This involves computing messages based on neighboring nodes and updating node embeddings.

During the node scoring stage, the final embeddings are used to score and rank nodes, reflecting merchant location performance and risks (e.g., potential closure of a merchant store).

Further, the optimal merchant location determination module 226 is configured to determine a set of optimal merchant locations from the plurality of merchant locations 106 based, at least in part, on the corresponding rank of each merchant location node.

Graph Neural Networks (GNNs) or the GNN ML model 234 are AI or ML models that provide a general framework for defining deep neural networks on graph data. In particular, the key idea behind GNNs is to generate representations of the nodes using both the structure of the graph and feature information associated with the nodes. In an instance, the GNN ML model 234 can be derived as a generalization of convolutions to non-Euclidean data as a differentiable variant of belief propagation, as well as by analogy to classic graph isomorphism tests.

The defining feature of the GNN ML model 234 is that it uses a form of neural message passing in which vector messages are exchanged between nodes and updated using neural networks. During each message-passing iteration in a GNN ML model 234, a hidden embedding H_{U} corresponding to each node Vᵤ∈V is updated according to information aggregated from Vᵤ's graph neighborhood N(Vᵤ). This message-passing update where UPDATE and AGG are arbitrary differentiable functions (i.e., neural networks) and mN(Vᵤ) is the “message” that is aggregated from Vᵤ 's graph neighborhood N(Vᵤ). Here, superscripts are used to distinguish the embeddings and functions at different iterations of message passing. At each iteration k of the GNN ML model 234, the AGG function takes as input the set of embeddings of the nodes in Vᵤ 's graph neighborhood N(Vᵤ) and generates a message m(k) based on this aggregated neighborhood information. The N(Vᵤ) update function UPDATE then combines the message m(k) with the previous N(Vᵤ)(k−1)(k) embedding v of the node Vᵤ to generate the updated embedding hᵤ. In a non-limiting example, the hidden embedding can be expressed using the following equation:

$$\begin{matrix}{( {H}_{u} )}^{K + 1} = {UPDATE}^{( K )} ( {H}_{u}^{( K )} , A G {G}^{( K )} ( {h}_{v} , ∀ v ∈ N ( {V}_{u} ) ) ) \\ = {UPDATE}^{( K )} ( {h}_{u}^{k} , {m}_{N ( {V}_{u} )}^{( k )} )\end{matrix} \qquad Eqn . 3$$

Initially, embeddings at iteration, K=0 are set to the input features for all the nodes, i.e., hu=Xᵤ, ∀u∈V. After running K iterations of the GNN message passing, the output of the final layer of the GNN ML model 234 can be used to define the embeddings for each node. In a non-limiting example, the final embedding can be expressed using the following equation:

$$Z = h ( k ) , ∀ u ∈ V \qquad Eqn . 4$$

It should be noted that GNNs generated in this manner are permutation equivariant by design because the AGGREGATE function requires a set as an input.

In another embodiment, the optimal merchant location determination module 226 is configured to process, by a GNN ML model 234, the geospatial merchant graph to rank each merchant location node and each candidate merchant location node of the geospatial merchant graph. Further, the optimal merchant location determination module 226 is configured to determine a set of optimal candidate merchant locations from one or more candidate merchant locations based, at least in part, on the corresponding rank of each candidate merchant location node.

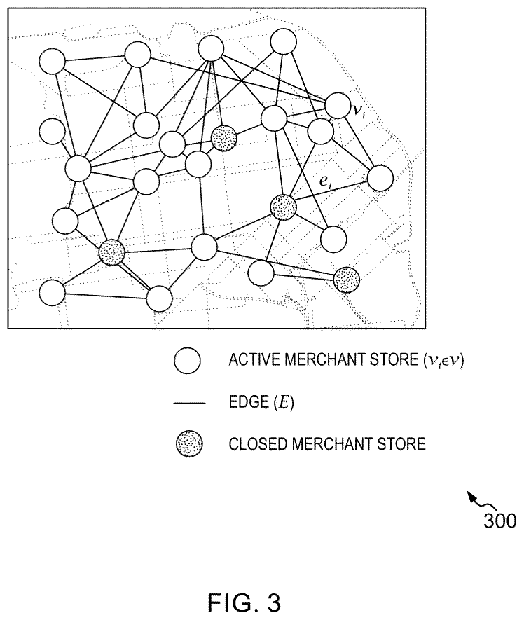

FIG. 3 illustrates an exemplary representation of a geospatial merchant graph 300, in accordance with an embodiment of the present disclosure. As described earlier, the graph generation module 222 of the server system 200 is configured to generate a geospatial merchant graph 300 based, at least in part, on the corresponding transaction feature set, the corresponding social media feature set, and the corresponding label of each merchant location.

As may be understood, a geospatial merchant graph 300 or a homogeneous merchant graph may be represented by G=(V, E, X, Y), where V={v₁, . . . , v_{N}} is the set of V nodes. E is the set of edges. The edge between nodes u, v∈V is denoted as (u, v)∈E. X={x₁, x₂ . . . , x_{N}} denotes the features of the node and Y={y₁, . . . , y_{N}} represents the labels of nodes. Let K denote the total class number.

The goal is to learn a representation vector hᵥ and a mapping function f(.) to predict the class label yᵥ of node v, i.e., ŷᵥ=f(hᵥ). Each node vᵢ∈V has a label yᵢ. In general, at K=2, i.e., yᵢ=0 for fraud and yᵢ=1 for non-fraud.

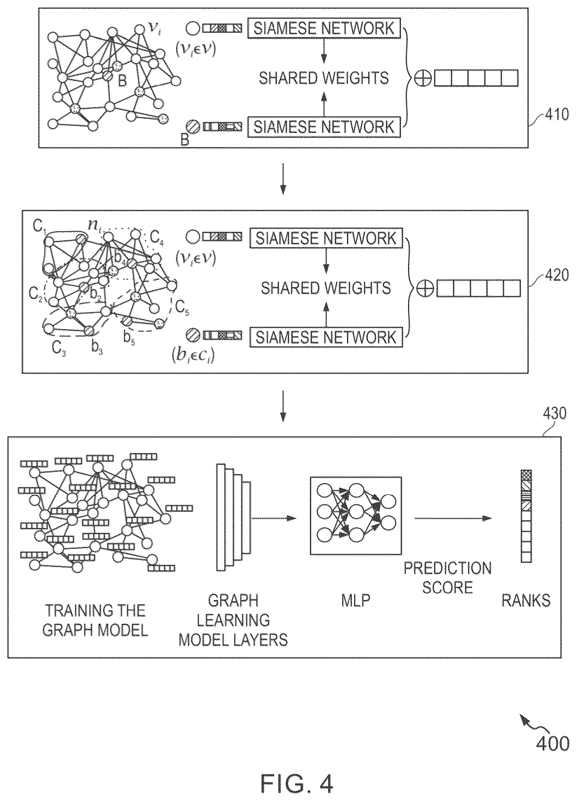

In an embodiment, the server system 200 is configured to generate a model framework that predicts the likelihood that a merchant node will achieve a closed state (i.e., an inactive state) in the next two quarters. This task can be divided into two sub-tasks. One, is where the Siamese ML model 232 (depicted as a Siamese network in FIG. 4) is leveraged to project the embeddings of a merchant node with respect to its area's benchmark merchant store into a latent space. This projection is performed such that the generated merchant-specific embedding for each merchant location is representative of how similar the node is to the benchmark node. Second, a graph classification task is performed by a GNN ML model 234 by analyzing the merchant nodes, and their embeddings. Further, a geo-spatial graph 300 network, i.e., the homogeneous merchant graph is created based on the graph classification task. This homogeneous merchant graph is used as input into graph neural network architecture to predict the state of the merchant location node for the next two quarters. It is understood that the geospatial merchant graph 300 is shown in FIG. 3 is obtained for San Francisco city. The labels of the graph ∈{active merchant flag indicating an active merchant store, inactive merchant flag indicating a closed merchant store}. A merchant is considered to be closed when it witnesses 0 transactions in the next two quarters of the training period.

To generate the graph, daily time series features are aggregated for all the merchant locations 106 in the geography for the specified time period (Quarter 1 of 2022 to Quarter 3 of 2022 in this exemplary case). These features are utilized as attributes of nodes and edges in the geospatial merchant graph 300.

The server system 200 is further configured to select user-merchant interactions for a specific period to generate a graph, G=(V, E), where V={v₁, . . . , vₙ} is the set of merchant locations 106 represented as V nodes and E is the set of edges represents interaction among the merchant locations 106 based on common cardholders or users from the cardholders 104. The number of common cardholders and the geo-spatial distance between the merchant locations 106 are used as edge attributes in the geospatial merchant graph 300. More specifically, for each merchant pair vᵢ, vⱼ there exists an edge eᵢⱼ between them if a common cardholder or user has transacted between merchant location vᵢ and merchant location vⱼ during that time period. In some instances, a threshold may be applied to the number of common cardholders or users before creating an edge. It is noted that the exemplary implementation described herein, the number of common users, and the geospatial distance between the two merchant locations as a vector of edge attributes. However, the same should not be construed as a limitation of the proposed approach, instead, different suitable edge definitions may also be used depending on the requirements of the aggregate merchants.

FIG. 4 illustrates an architecture of the framework for determining optimal merchant locations, in accordance with an embodiment of the present disclosure.

In an embodiment, the server system 200 can use benchmark merchant locations to assess the performance of different merchant locations 106 or stores. The benchmark merchant locations are generated such that they represent the highest performers in the various criteria specified by the aggregate merchant. In other words, the concept of a benchmark merchant helps to inculcate different aggregate merchant or stakeholder requirements including high transaction volume, low fraud counts, low chargebacks, etc., among other suitable criteria. To assess the performance of the various merchant locations, the benchmark merchant locations along with other merchant locations are fed into the Siamese ML model 232 (i.e., a Siamese network) using the contrastive loss to create criteria-specific feature embeddings for the nodes. This process is depicted by block 410 of FIG. 4. As depicted, for every node vᵢ∈V, the time series features are compared with a benchmark merchant (B) defined at a full-graph level to generate a 64-bit node-level embedding, i.e., the merchant specific embedding. It is noted that the Siamese networks share the same weights, i.e., the shared weights.

In various instances, benchmark merchant locations can either be selected from the communities (see, C₁, C₂, C₃, C₄, or C₅) obtained from standard community detection algorithms like “Louvain” or as a single merchant location from the entire merchant location graph. In an implementation, the Louvain method of community detection based on the maximization of the modularity score for each identified community can be used to form merchant communities. The merchant communities are created among the plurality of merchants, and then benchmark merchant locations for each merchant community are created. The Louvain method is a hierarchical clustering algorithm that recursively merges communities into a single node and executes modularity clustering on the condensed graphs. The results obtained using the two criteria are described later. This process is depicted by block 420 of FIG. 4. As depicted, for every node vᵢ∈V, the time series features are compared with benchmark merchants (bᵢ∈Cᵢ) defined at a community level. These communities (Cᵢ∈C) are obtained using the Louvain Algorithm on the complete graph to generate a 64-bit node-level embedding, i.e., the merchant specific embedding.

Further, block 430 of FIG. 4 represents the process for training the GNN ML model 234. As depicted, for every node vᵢ∈V, a probability score of whether the store would continue to operate in the next 2 quarters is predicted. The layers of the GNN ML model 234 can be replaced and interchanged between GNN, GCN, GraphSAGE layers, etc. A formal comparison of all graph models has also been considered during experimentation described later on. The softmax predictions (higher value of score denoting higher likelihood of store going out of business in the next two quarters) obtained as model output is arranged to rank order the merchant scores.

At this stage, the GNN ML model 234 is trained to predict whether a store will remain operational in the next two quarters. Inputs to block 430 include merchant-specific embeddings generated by the Siamese ML model 232 and geospatial graph features. The GNN ML model 234 learns patterns in node connectivity and features to predict the likelihood of store closures. Herein, the GNN ML model 234 utilizing merchant-specific embeddings that capture feature similarities with benchmark locations, as input. Then, layered processing is performed by the GNN ML model 234. In layered processing, multiple GNN layers process the graph, aggregating information from neighboring nodes at each step. Then, the final layer of the GNN computes softmax predictions for each node. Nodes are ranked based on these scores, where higher scores indicate a higher likelihood of closure. These ranked results help merchants identify underperforming stores and areas for optimization or closure.

To determine the real world effectiveness of the proposed approach, experiments have been conducted to determine the characteristics of real data and stores from San Francisco City. During experimentation, the proposed novel model pipeline using the Siamese ML model 232 and Graph Classifier ML model, i.e., an example of the GNN ML model 234 have been implemented to facilitate aggregate merchants in their decision-making process of optimizing store locations.

To evaluate the proposed framework, approximately 9 months of real data consisting of approximately 3,433 merchant stores from approximately 5 different industries was considered. The proposed approach or model was tested using different embedding settings depending on the geographical scale of the aggregate merchant's network. The performance of embedding different settings, and the performance along with the behavior of different graph neural networks while ranking the nodes have been checked as well.

As would be apparent from the experimental results shown in Table 1, the RGCN shows the highest approximate accuracy between 80% to 89% in a single benchmark setting for embeddings, but the recall takes a dip in this case. Better performance is achieved using the GCN model where approximate accuracy lies between 75% to 79% but recall@3 is the highest at about 45% to 49%. This improved recall can be attributed to the fact that GCN is best able to capture the localized features of the neighborhood of the particular store. Comparable results are also presented in Table 1 in the case of community and single benchmark settings for GCN. It is noted that the results shown in Table 1 are approximate in nature.

Through these experiments, each setting is critically examined to evaluate the effectiveness of each component of the proposed exemplary settings. For instance, embedding generated using a single benchmark merchant or multiple benchmark merchant locations at a community level, edges of the graph being common cards or distance and different GNNs and impacts of each of these on the metrics used for comparison. The results from these experiments show that each of the components contributes to evaluating the performance and ranking of the merchant locations 106 and proposed model framework performs well for these factors.

The data set used to perform the experiments consisted of real transaction data anonymized and aggregated for the time period ranging from Quarter 1 to Quarter 3 of a specific year. The merchant and cardholder identities along with the industry label information of the merchants were anonymized. Further, merchants with extremely low and high transactions were removed from the data set as these merchants will add noise and bias in the graph, respectively. Furthermore, the edges of the graph were pruned based on the distance, as nodes that are far apart from each other contributed very little information at the time of message passing at the node aggregation step, and the model was also easier to train. The graph used for the experiments contains approximately 3,433 nodes and approximately 931,788 edges. The raw features fetched from the transaction data of the stores were converted into merchant embeddings using the Siamese ML model 232 during the process of development. These embeddings were created to capture similarities and differences between the benchmark merchant location or store and the merchant location or store, further allowing the data to be converted into a more useful format that captures the relative differences between the raw features of the two stores.

TABLE 1
Performance metrics for various graph-based models in the context of merchant
recommendation. (The results are approximate and organized based on different
model architectures, evaluation metrics, and feature representations.)

| | | | accuracy | accuracy | Recall | Recall | ndcg | Ndcg | |
|---|---|---|---|---|---|---|---|---|---|
| | | | @3 | @5 | @3 | @5 | @3 | @5 | rocauc |
| GCN | Community | common | 0.69 | 0.53 | 0.76 | 0.86 | 0.72 | 0.69 | 0.72 |
| | | cards | | | | | | | |
| | | distance | 0.66 | 0.47 | 0.80 | 0.88 | 0.72 | 0.68 | 0.72 |
| | Single | common | 0.7 | 0.26 | 0.41 | WMI | 0.71 | 0.66 | 6.64 |
| | Benchmark | cards | | | | | | | |
| | | distance | 0.60 | 0.60 | 0.65 | 0.65 | 0.68 | 0.68 | 0.62 |
| Cluster | Community | common | 0.87 | 0.79 | 0.01 | 0.11 | 0.64 | 0.64 | 0.50 |
| GCN | | cards | | | | | | | |
| | | distance | 0.87 | 0.79 | 0.01 | 0.10 | 0.63 | 0.63 | 0.50 |
| | Single | common | 0.12 | 0.12 | LOO | 100 | 0.64 | 0.64 | 0.30 |
| | Benchmark | cards | | | | | | | |
| | | distance | 0.12 | 0.12 | 1.00 | 1.00 | 0.64 | 0.64 | 0.50 |
| Graph | Community | common | 0.84 | 0.82 | 0.28 | 0.38 | 0.71 | 0.72 | 0.60 |
| SAGE | | cards | | | | | | | |
| | | distance | 0.86 | 0.79 | 0.20 | 0.39 | 0.71 | 0.71 | 0.57 |
| | Single | common | 0.86 | 0.85 | 0.19 | 0.19 | 0.70 | 0.70 | 0.51 |
| | Benchmark | cards | | | | | | | |
| | | distance | 0.86 | 0.86 | 0.19 | 0.19 | 0.70 | 0.70 | 0.57 |
| RGCN | Community | common | 0.86 | 0.69 | 0.19 | 0.40 | 0.70 | 0.67 | 0.57 |
| | | cards | | | | | | | |
| | | distance | 0.86 | 0.86 | 0.19 | 0.20 | 0.70 | 0.71 | 0.57 |
| | Single | common | 0.86 | 0.12 | 0.19 | 100 | 0.70 | 0.64 | 0.51 |
| | Benchmark | cards | | | | | | | |
| | | distance | 0.86 | 0.35 | 0.19 | (0.69) | 0.70 | 0.64 | 0.57 |

During the experimentation, the proposed model framework was implemented in Tensorflow 2.11.0 with Python 3.7.3 where the graph was built using stellargraph 1.2.1 and each of the experiments was implemented on Linux system with 4 cores and 64 GB memory.

For the supervised node classification problem statement, the comparison between different models is performed with the help of various well-known metrics such as AUC-ROC along with Accuracy, Recall, and Normalized Discounted Cumulative Gain (NDCG). Accuracy: Accuracy is the ratio of correctly predicted instances to the number of instances in the dataset, which is calculated at a threshold giving a maximum F1 score. So, the higher values of AUC-ROC and Accuracy indicate higher performance of the model. Accuracy@3 and Accuracy@5 represent results in the top 3 and 5 deciles of the scores. Recall: also known as Sensitivity or True Positive Rate, measures the ability of the model to correctly identify positive instances among the total actual positive instances. It is calculated as the ratio of true positives to the sum of true positives and false negatives. NDCG serves as a metric commonly utilized in information retrieval and recommendation systems. It assesses the ranking quality of the model's predictions, considering both the relevance and ranking of the predicted instances. AUC-ROC: This refers to the area under the ROC curve, which can be defined using the following exemplary equation:

$$AUC = {\sum }_{i = 1}^{N - 1} \frac{1}{2} ( {x}_{i + 1} - {x}_{i} ) \cdot ( {y}_{i} + {y}_{i + 1} ) \qquad Eqn . 5$$

Here, N is a total number of points (thresholds) in ROC Curve, xᵢ and xᵢ₊₁ are the False Positive Rates (FPR) at two consecutive thresholds and yᵢ and yᵢ₊₁ are the True Positive Rates (TPR) at the same two consecutive thresholds.

There are two learning paradigms, transductive learning and inductive learning. Transductive learning only aims to apply the classifier ‘f’ on the unlabeled instances observed at training time, and the classifier does not generalize to unobserved instances. Inductive learning, on the other hand, aims to learn a parameterized classifier ‘f’ that is generalizable to unobserved instances. Results from several state-of-the-art graph neural network methods to compare with the proposed model's performance in node classification tasks.

GCN: Graph convolution Network is a graph neural network architecture that is accomplished by first-order estimation of Spectral Graph Convolution in the form of a message-passing network where the information is propagated along the neighboring nodes within the graph. GraphSAGE is another graph neural network that samples and aggregates neighbors for each node to encode the full neighborhood structure, which improves generalization and reduces overfitting for node classification on large graphs.

R-GCNs can explicitly model relationships between nodes, which is important for node classification, and generalize to new graphs. It extends the idea of Graph Convolutional Networks (GCNs) to handle the complexities of heterogeneous graphs with multiple types of nodes and relationships.

Cluster-GCN outperforms other GNNs on transductive node classification tasks by clustering the graph into subgraphs and training GNNs on each subgraph, which improves scalability and performance. Specifically, in a transductive experimental setting, utilizing a complete graph from Quarter 2 of 2021 to Quarter 1 of 2022 as input. Two sets were created from this data: a training set and a validation set, with 50% of merchants allocated to each set. For the evaluation of our model's performance on unseen data, results on the test set, spanning from Quarter 3 of 2021 to Quarter 2 of 2022, are determined.

The reported test set performance corresponds to the epoch at which optimal performance on the training set was achieved. The outcomes for this set of 1717 previously unseen merchants are presented in Table 1. The results of these experiments reveal that the proposed innovative approach of selecting merchants from communities obtained through the standard community detection model significantly bolstered the model's performance. Notably, high recalls at elevated accuracy levels are also observed. Additionally, it's noteworthy that Graph Convolutional Networks (GCN) exhibited superior performance, followed by GraphSAGE in the obtained results.

In a non-limiting example, a pseudo code for node feature generation using the Siamese ML model 232 in a single benchmark merchant location mode is given below:

Input: G = (V, E, X, Y)
Select Top merchant based on stakeholder priorities: K′
for uᵢ ∈ V′ do
for u ∈ V do

\vec{u} = ||Siamese(Xᵤ, X_{K}′)||

end for
end for
\vec{u} is the node feature vector for the node u

In a non-limiting example, a pseudo code for node feature generation using the Siamese ML model 232 in community benchmark merchant location mode is given below:

Input: G = (V, E, X, Y)
Perform Louvain Community detection on G, to get set of communities:
C for cᵢ ∈ C′ do
Select Top merchant based on stakeholder priorities or aggregate
merchant community criteria:
K_{C}_{ᵢ}, for u ∈ V_{C}_{ᵢ} do
$\vec{u} = ‖ Siamese ( {X}_{u} , {X}_{{k}_{{cI}_{i}}} ) ‖$
end for
\vec{u} is the node feature vector for the node u

In a non-limiting example, a pseudo code for processing the graph using the GNN ML model 234 is given below:

Input: G = (N, E, X, Y), \vec{u} (Node feature vector from
Siamese network)
Initialize GNN model parameters: θ
Initialize node embeddings: H⁽⁰⁾ = X
for l = 1 to L do Iterate over layers
Aggregate neighbor information:

H^{(l)} = σ [symbol] W^{(l)} · H^{(l-1)} + b^{(l)})

end for
Concatenate Siamese features:
Final Node Features = Concatenate (\vec{u}, H^{(L)})
Apply final prediction layer.
Ŷ = Softmax (FC (Final Node Features))
Train the GNN model using labeled data.

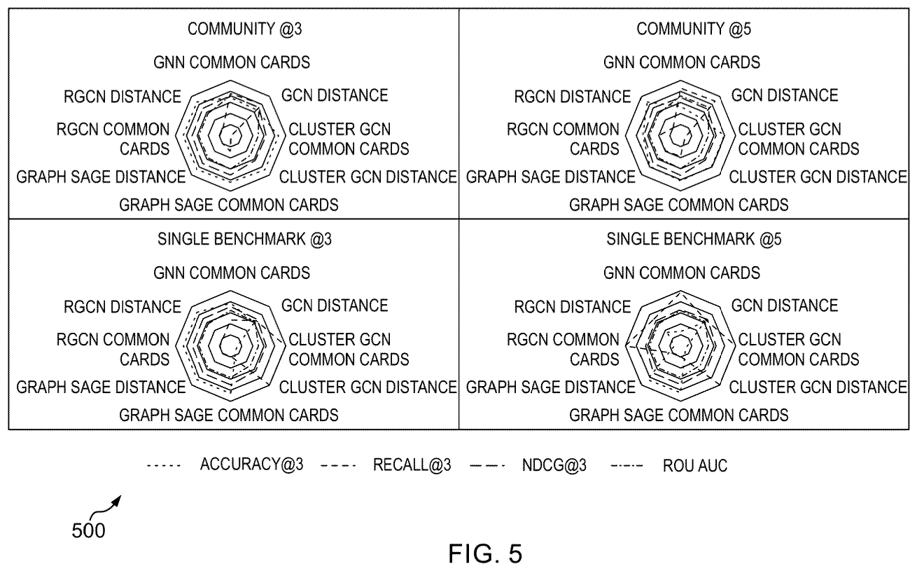

FIG. 5 illustrates a representation 500 of various graphs for depicting the performance of four graph neural network models on community and single merchant benchmark mode or setting, with edges weighted by common cardholders or physical distance, in accordance with an embodiment of the present disclosure.

The graph shows the performance of four graph neural network models (GCN, RGCN, Cluster GCN, and GraphSAGE) on two different benchmark settings (community and single benchmark), with edges weighted by either common cards or physical distance. On the community benchmark, all four models perform better with common cards as edge weights than with physical distance as edge weights. This suggests that common cards are a more informative signal for community detection than physical distance.

On the single benchmark, the performance of the models is more mixed. GCN and GraphSAGE perform better with common cards as edge weights, while Cluster GCN and RGCN perform better with physical distance as edge weights. This suggests that the best way to weigh edges for a particular task may depend on the specific task and the model being used. Overall, the results suggest that graph neural networks can be used to effectively detect communities in merchant networks, and that the choice of edge weights can have a significant impact on performance.

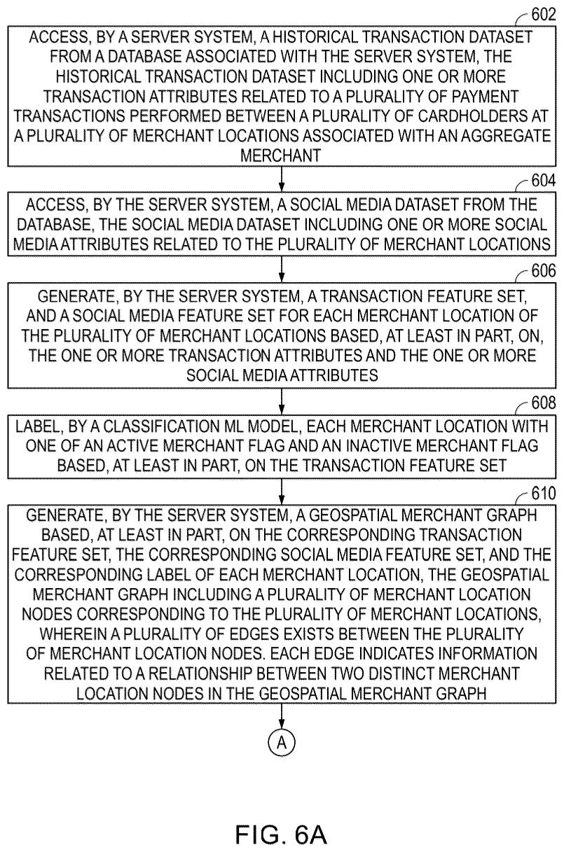

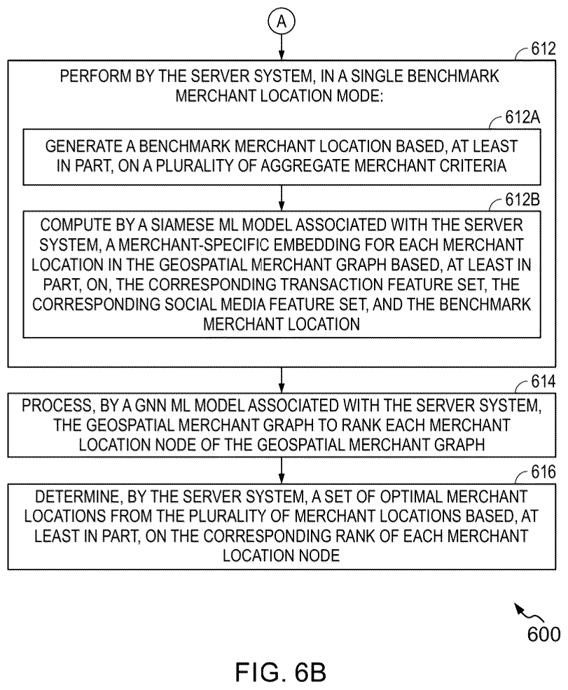

FIGS. 6A and 6B, collectively, illustrate a process flow diagram depicting a method 600 for determining a set of optimal merchant locations from the plurality of merchant locations in a single benchmark merchant location mode, in accordance with an embodiment of the present disclosure. The method 600 depicted in the flow diagram may be executed by, for example, the server system 200. The sequence of operations of the method 600 may not be necessarily executed in the same order as they are presented. Further, one or more operations may be grouped and performed in the form of a single step, or one operation may have several sub-steps that may be performed in parallel or in a sequential manner. Operations of the method 600, and combinations of operations in the method 600 may be implemented by, for example, hardware, firmware, a processor, circuitry, and/or a different device associated with the execution of software that includes one or more computer program instructions. The plurality of operations is depicted in the process flow of the method 600. The process flow starts at operation 602.

At 602, the method 600 includes accessing, by a server system such as server system 200 of FIG. 2, a historical transaction dataset 228 from a database 204 associated with the server system 200. The historical transaction dataset 228 includes one or more transaction attributes related to a plurality of payment transactions performed between a plurality of cardholders 104 at a plurality of merchant locations 106 associated with an aggregate merchant.

At 604, the method 600 includes accessing, by the server system 200, a social media dataset 230 from the database 204. The social media dataset 230 includes one or more social media attributes related to the plurality of merchant locations 106.

At 606, the method 600 includes generating, by the server system 200, a transaction feature set, and a social media feature set for each merchant location of the plurality of merchant locations 106 based, at least in part, on, the one or more transaction attributes and the one or more social media attributes.

At 608, the method 600 includes labeling, by a classification ML model, each merchant location with one of an active merchant flag and an inactive merchant flag based, at least in part, on the transaction feature set.

At 610, the method 600 includes generating, by the server system 200, a geospatial merchant graph 300 based, at least in part, on the corresponding transaction feature set, the corresponding social media feature set, and the corresponding label of each merchant location. The geospatial merchant graph 300 includes a plurality of merchant location nodes corresponding to the plurality of merchant locations 106, wherein a plurality of edges exists between the plurality of merchant location nodes. Each edge indicates information related to a relationship between two distinct merchant location nodes in the geospatial merchant graph 300.

At 612, the method 600 includes performing, by the server system 200, in a single benchmark merchant location mode operations 612A and 612B.

At 612A, the method 600 includes generating a benchmark merchant location based, at least in part, on a plurality of aggregate merchant criteria.

At 612B, the method 600 includes computing by a Siamese ML model 232 associated with the server system 200, a merchant-specific embedding for each merchant location in the geospatial merchant graph based, at least in part, on, the corresponding transaction feature set, the corresponding social media feature set, and the benchmark merchant location.

At 614, the method 600 includes processing, by a GNN ML model 234 associated with the server system 200, the geospatial merchant graph to rank each merchant location node of the geospatial merchant graph.

At 616, the method 600 includes determining, by the server system 200, a set of optimal merchant locations from the plurality of merchant locations 106 based, at least in part, on the corresponding rank of each merchant location node.

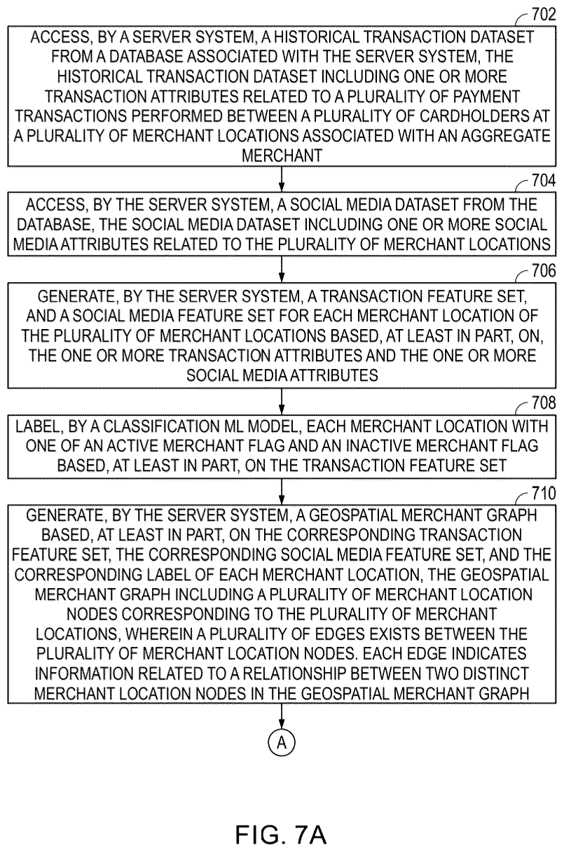

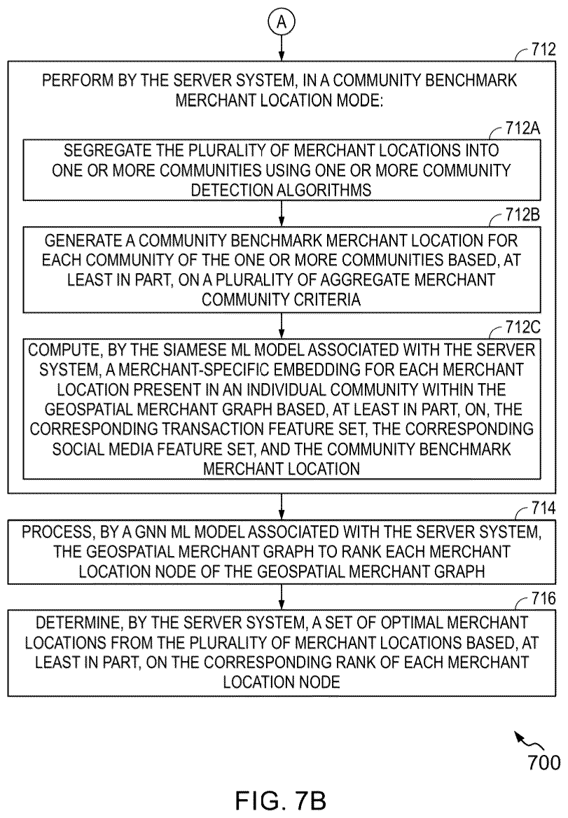

FIGS. 7A and 7B, collectively, illustrate a process flow diagram depicting a method 700 for determining a set of optimal merchant locations from the plurality of merchant locations in a community benchmark merchant location mode, in accordance with an embodiment of the present disclosure. The method 700 depicted in the flow diagram may be executed by, for example, the server system 200. The sequence of operations of the method 700 may not be necessarily executed in the same order as they are presented. Further, one or more operations may be grouped and performed in the form of a single step, or one operation may have several sub-steps that may be performed in parallel or in a sequential manner. Operations of the method 700, and combinations of operations in the method 700 may be implemented by, for example, hardware, firmware, a processor, circuitry, and/or a different device associated with the execution of software that includes one or more computer program instructions. The plurality of operations is depicted in the process flow of the method 700. The process flow starts at operation 702.

At 702, the method 700 includes accessing, by a server system 200, a historical transaction dataset from a database 204 associated with the server system 200. The historical transaction dataset includes one or more transaction attributes related to a plurality of payment transactions performed between a plurality of cardholders 104 at a plurality of merchant locations 106 associated with an aggregate merchant.

At 704, the method 700 includes accessing, by the server system 200, a social media dataset from the database 204. The social media dataset includes one or more social media attributes related to the plurality of merchant locations 106.

At 706, the method 700 includes generating, by the server system 200, a transaction feature set, and a social media feature set for each merchant location of the plurality of merchant locations 106 based, at least in part, on, the one or more transaction attributes and the one or more social media attributes.

At 708, the method 700 includes labeling, by a classification ML model, each merchant location with one of an active merchant flag and an inactive merchant flag based, at least in part, on the transaction feature set.

At 710, the method 700 includes generating, by the server system 200, a geospatial merchant graph 300 based, at least in part, on the corresponding transaction feature set, the corresponding social media feature set, and the corresponding label of each merchant location. The geospatial merchant graph 300 includes a plurality of merchant location nodes corresponding to the plurality of merchant locations, wherein a plurality of edges exists between the plurality of merchant location nodes. Each edge indicates information related to a relationship between two distinct merchant location nodes in the geospatial merchant graph 300.

At 712, the method 700 includes performing, by the server system 200, in a community benchmark merchant location mode operations 712A, 712B and 712C.

At 712A, the method 700 includes segregating the plurality of merchant locations into one or more communities using one or more community detection algorithms.

At 712B, the method 700 includes generating a community benchmark merchant location for each community of the one or more communities based, at least in part, on a plurality of aggregate merchant community criteria.

At 712C, the method 700 includes computing, by the Siamese ML model 232 associated with the server system 200, a merchant-specific embedding for each merchant location present in an individual community within the geospatial merchant graph 300 based, at least in part, on, the corresponding transaction feature set, the corresponding social media feature set, and the community benchmark merchant location.

At 714, the method 700 includes processing, by a GNN ML model 234 associated with the server system 200, the geospatial merchant graph 300 to rank each merchant location node of the geospatial merchant graph 300.

At 716, the method 700 includes determining, by the server system 200, a set of optimal merchant locations from the plurality of merchant locations 106 based, at least in part, on the corresponding rank of each merchant location node.

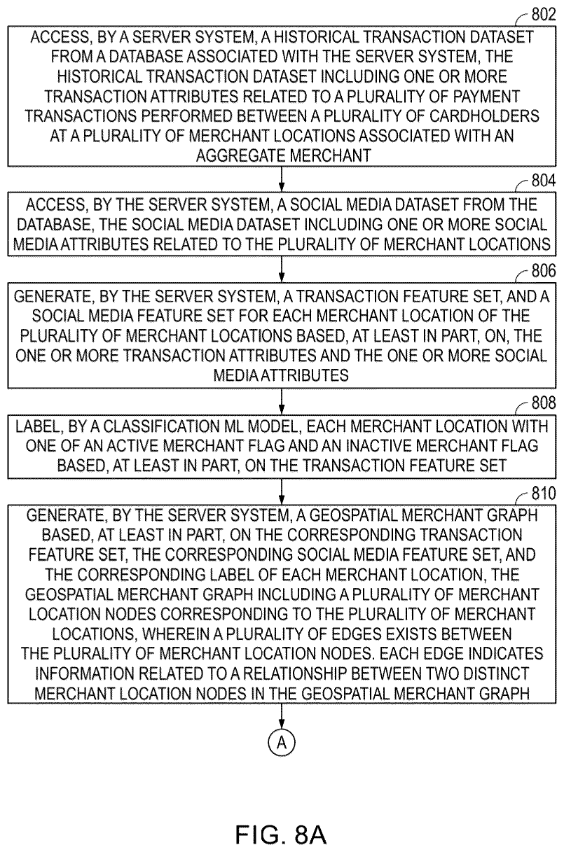

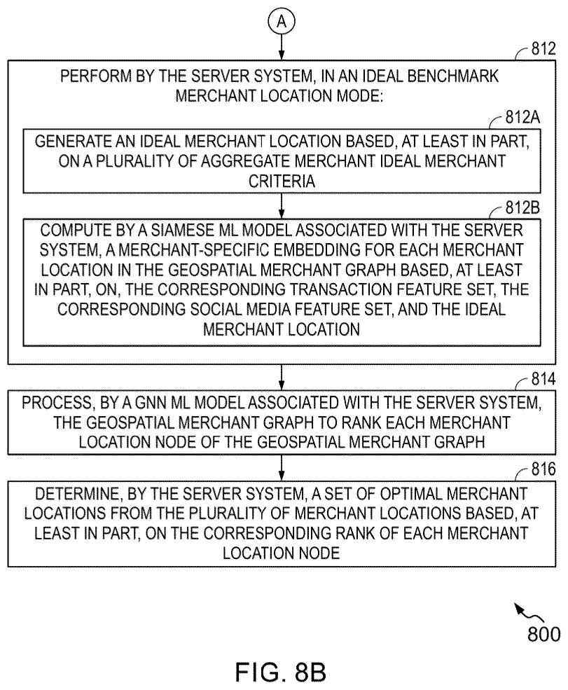

FIGS. 8A and 8B, collectively, illustrate a process flow diagram depicting a method 800 for determining a set of optimal merchant locations from the plurality of merchant locations in an ideal benchmark merchant location mode, in accordance with an embodiment of the present disclosure. The method 800 depicted in the flow diagram may be executed by, for example, the server system 200. The sequence of operations of the method 800 may not be necessarily executed in the same order as they are presented. Further, one or more operations may be grouped and performed in the form of a single step, or one operation may have several sub-steps that may be performed in parallel or in a sequential manner. Operations of the method 800, and combinations of operations in the method 800 may be implemented by, for example, hardware, firmware, a processor, circuitry, and/or a different device associated with the execution of software that includes one or more computer program instructions. The plurality of operations is depicted in the process flow of the method 800. The process flow starts at operation 802.

At 802, the method 800 includes accessing, by a server system 200, a historical transaction dataset from a database 204 associated with the server system 200. The historical transaction dataset includes one or more transaction attributes related to a plurality of payment transactions performed between a plurality of cardholders 104 at a plurality of merchant locations 106 associated with an aggregate merchant.

At 804, the method 800 includes accessing, by the server system 200, a social media dataset from the database 204. The social media dataset includes one or more social media attributes related to the plurality of merchant locations 106.

At 806, the method 800 includes generating, by the server system 200, a transaction feature set, and a social media feature set for each merchant location of the plurality of merchant locations 106 based, at least in part, on, the one or more transaction attributes and the one or more social media attributes.

At 808, the method 800 includes labeling, by a classification ML model, each merchant location with one of an active merchant flag and an inactive merchant flag based, at least in part, on the transaction feature set.

At 810, the method 800 includes generating, by the server system 200, a geospatial merchant graph 300 based, at least in part, on the corresponding transaction feature set, the corresponding social media feature set, and the corresponding label of each merchant location. The geospatial merchant graph 300 includes a plurality of merchant location nodes corresponding to the plurality of merchant locations 106, wherein a plurality of edges exists between the plurality of merchant location nodes. Each edge indicates information related to a relationship between two distinct merchant location nodes in the geospatial merchant graph 300.

At 812, the method 800 includes performing, by the server system 200, in an ideal benchmark merchant location mode operations 812A and 812B.

At 812A, the method 800 includes generating an ideal merchant location based, at least in part, on a plurality of aggregate merchant ideal merchant criteria.

At 812B, the method 800 includes computing by a Siamese ML model 232 associated with the server system 200, a merchant-specific embedding for each merchant location in the geospatial merchant graph 300 based, at least in part, on, the corresponding transaction feature set, the corresponding social media feature set, and the ideal merchant location.

At 814, the method 800 includes processing, by a GNN ML model 234 associated with the server system 200, the geospatial merchant graph 300 to rank each merchant location node of the geospatial merchant graph 300.

At 816, the method 800 includes determining, by the server system 200, a set of optimal merchant locations from the plurality of merchant locations 106 based, at least in part, on the corresponding rank of each merchant location node.

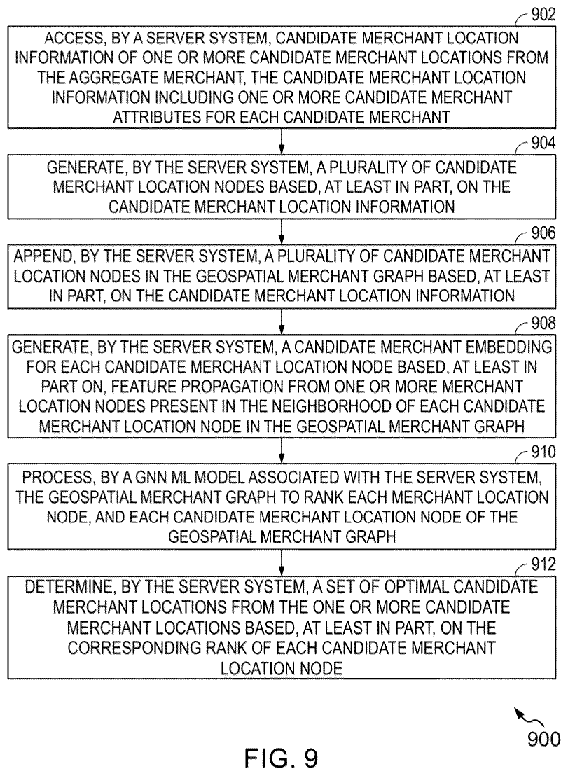

FIG. 9 illustrates a process flow diagram depicting a method 900 for determining a set of optimal candidate merchant locations from one or more candidate merchant locations, in accordance with an embodiment of the present disclosure. The method 900 depicted in the flow diagram may be executed by, for example, the server system 200. The sequence of operations of the method 900 may not be necessarily executed in the same order as they are presented. Further, one or more operations may be grouped and performed in the form of a single step, or one operation may have several sub-steps that may be performed in parallel or in a sequential manner. Operations of the method 900, and combinations of operations in the method 900 may be implemented by, for example, hardware, firmware, a processor, circuitry, and/or a different device associated with the execution of software that includes one or more computer program instructions. The plurality of operations is depicted in the process flow of the method 900. The process flow starts at operation 902.

At 902, the method 900 includes accessing, by a server system 200, candidate merchant location information of one or more candidate merchant locations from the aggregate merchant, the candidate merchant location information including one or more candidate merchant attributes for each candidate merchant.

At 904, the method 900 includes generating, by the server system 200, a plurality of candidate merchant location nodes based, at least in part, on the candidate merchant location information.

At 906, the method 900 includes appending, by the server system 200, a plurality of candidate merchant location nodes in the geospatial merchant graph 300 based, at least in part, on the candidate merchant location information.

At 908, the method 900 includes generating, by the server system 200, a candidate merchant embedding for each candidate merchant location node based, at least in part on, feature propagation from one or more merchant location nodes present in the neighborhood of each candidate merchant location node in the geospatial merchant graph 300.

At 910, the method 900 includes processing, by a GNN ML model 234 associated with the server system 200, the geospatial merchant graph 300 to rank each merchant location node, and each candidate merchant location node of the geospatial merchant graph 300.

At 912, the method 900 includes determining, by the server system 200, a set of optimal candidate merchant locations from the one or more candidate merchant locations based, at least in part, on the corresponding rank of each candidate merchant location node.

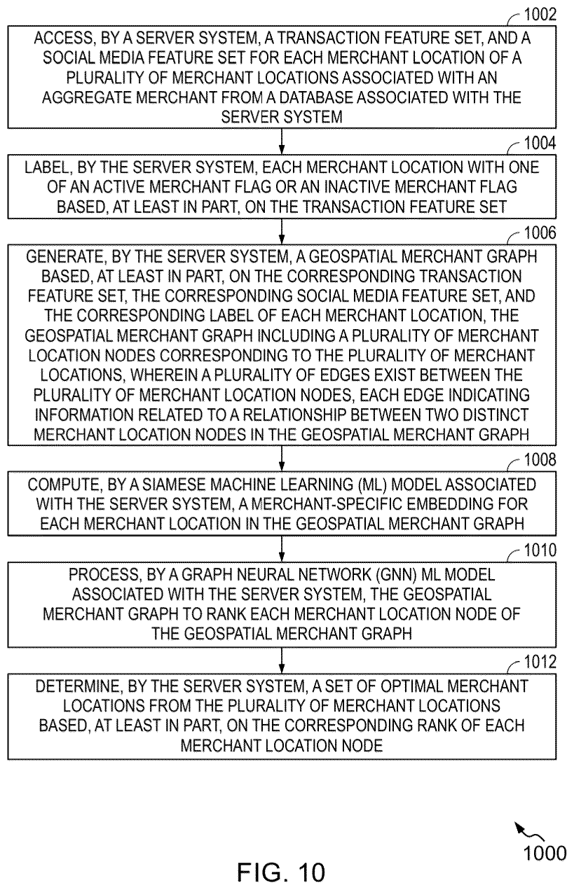

FIG. 10 illustrates a process flow diagram depicting a method 1000 for determining a set of optimal merchant locations from the plurality of merchant locations, in accordance with an embodiment of the present disclosure. The method 1000 depicted in the flow diagram may be executed by, for example, the server system 200. The sequence of operations of the method 1000 may not be necessarily executed in the same order as they are presented. Further, one or more operations may be grouped and performed in the form of a single step, or one operation may have several sub-steps that may be performed in parallel or in a sequential manner. Operations of the method 1000, and combinations of operations in the method 1000 may be implemented by, for example, hardware, firmware, a processor, circuitry, and/or a different device associated with the execution of software that includes one or more computer program instructions. The plurality of operations is depicted in the process flow of the method 1000. The process flow starts at operation 1002.

At 1002, the method 1000 includes accessing, by a server system 200, a transaction feature set, and a social media feature set for each merchant location of a plurality of merchant locations associated with an aggregate merchant from a database 204 associated with the server system 200.

At 1004, the method 1000 includes labeling, by the server system 200, each merchant location with one of an active merchant flag or an inactive merchant flag based, at least in part, on the transaction feature set;

At 1006, the method 1000 includes generating, by the server system 200, a geospatial merchant graph 300 based, at least in part, on the corresponding transaction feature set, the corresponding social media feature set, and the corresponding label of each merchant location. Herein, the geospatial merchant graph 300 includes a plurality of merchant location nodes corresponding to the plurality of merchant locations 106. A plurality of edges exist between the plurality of merchant location nodes, such that each edge indicates information related to a relationship between two distinct merchant location nodes in the geospatial merchant graph 300.

At 1008, the method 1000 includes computing, by a Siamese Machine Learning (ML) model 232 associated with the server system 200, a merchant-specific embedding for each merchant location in the geospatial merchant graph 300.

At 1010, the method 1000 includes processing, by a Graph Neural Network (GNN) ML model 234 associated with the server system 200, the geospatial merchant graph 300 to rank each merchant location node of the geospatial merchant graph

At 1012, the method 1000 includes determining, by the server system 200, a set of optimal merchant locations from the plurality of merchant locations based, at least in part, on the corresponding rank of each merchant location node.

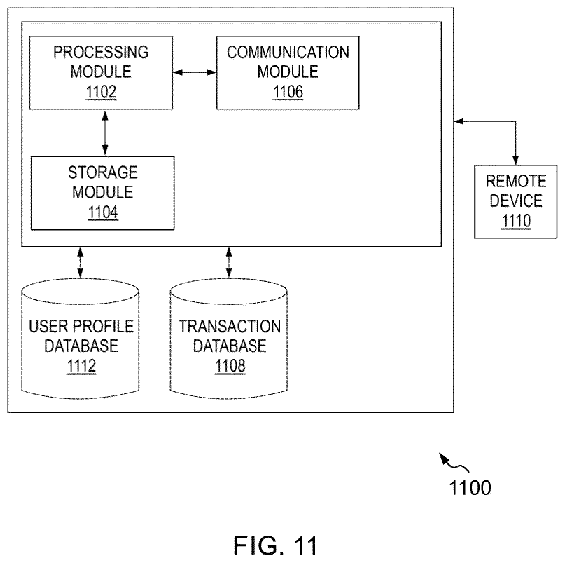

FIG. 11 illustrates a simplified block diagram of the acquirer server 1100, in accordance with an embodiment of the present disclosure. The acquirer server 1100 is an example of the acquirer server 108(1) of the plurality of acquirer servers 108 of FIG. 1. The acquirer server 1100 is associated with an acquirer bank/acquirer, in which a merchant may have an account, which provides a payment card. The acquirer server 1100 includes a processing module 1102 operatively coupled to a storage module 1104 and a communication module 1106. The components of the acquirer server 1100 provided herein may not be exhaustive, and the acquirer server 1100 may include more or fewer components than those depicted in FIG. 11. Further, two or more components may be embodied in one single component, and/or one component may be configured using multiple sub-components to achieve the desired functionalities. Some components of the acquirer server 1100 may be configured using hardware elements, software elements, firmware elements, and/or a combination thereof.

The storage module 1104 is configured to store machine-executable instructions to be accessed by the processing module 1102. Additionally, the storage module 1104 stores information related to, the contact information of the merchant, bank account number, availability of funds in the account, payment card details, transaction details, and/or the like. Further, the storage module 1104 is configured to store payment transactions.

In one embodiment, the acquirer server 1100 is configured to store profile data (e.g., an account balance, a credit line, details of the cardholders 104, account identification information, and a payment card number) in a transaction database 1108. The details of the cardholders 104 may include, but are not limited to, name, age, gender, physical attributes, location, registered contact number, family information, alternate contact number, registered e-mail address, etc.

The processing module 1102 is configured to communicate with one or more remote devices such as a remote device 1110 using the communication module 1106 over a network such as the network 116 of FIG. 1. The examples of the remote device 1110 include the server system 102, the payment server 114, the plurality of issuer servers 110, or other computing systems of the acquirer server 1100, and the like. The communication module 1106 can facilitate such operative communication with the remote devices and cloud servers using Application Program Interface (API) calls. The communication module 1106 is configured to receive a payment transaction request performed by the cardholders 104 via the network 116. The processing module 1102 receives payment card information, a payment transaction amount, customer information, and merchant information from the remote device 1110 (i.e., the payment server 114). The acquirer server 1100 includes a user profile database 1112 and the transaction database 1108 for storing transaction data. The user profile database 1112 may include information on cardholders. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular user, transaction location information, external data sources, and other internal data to evaluate each transaction.

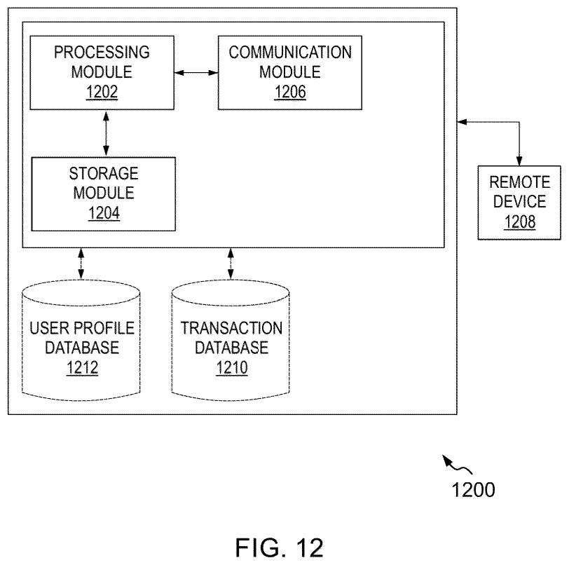

FIG. 12 illustrates a simplified block diagram of the issuer server 1200, in accordance with an embodiment of the present disclosure. The issuer server 1200 is an example of the issuer server 110(1) of the plurality of issuer servers 110 of FIG. 1. The issuer server 1200 is associated with an issuer bank/issuer, in which an account holder (e.g., the plurality of cardholders 104(1)-104(N)) may have an account, which provides a payment card (e.g., the payment cards 118(1)-118(N)). The issuer server 1200 includes a processing module 1202 operatively coupled to a storage module 1204 and a communication module 1206. The components of the issuer server 1200 provided herein may not be exhaustive, and the issuer server 1200 may include more or fewer components than those depicted in FIG. 12. Further, two or more components may be embodied in one single component, and/or one component may be configured using multiple sub-components to achieve the desired functionalities. Some components of the issuer server 1200 may be configured using hardware elements, software elements, firmware elements, and/or a combination thereof.

The storage module 1204 is configured to store machine-executable instructions to be accessed by the processing module 1202. Additionally, the storage module 1204 stores information related to, the contact information of the cardholders (e.g., the plurality of cardholders 104(1)-104(N)), a bank account number, availability of funds in the account, payment card details, transaction details, payment account details, and/or the like. Further, the storage module 1204 is configured to store payment transactions.

In one embodiment, the issuer server 1200 is configured to store profile data (e.g., an account balance, a credit line, details of the cardholders, account identification information, payment card number, etc.) in a database. The details of the cardholders may include, but are not limited to, name, age, gender, physical attributes, location, registered contact number, family information, alternate contact number, registered e-mail address, or the like of the cardholders, etc.

The processing module 1202 is configured to communicate with one or more remote devices such as a remote device 1208 using the communication module 1206 over a network such as the network 116 of FIG. 1. Examples of the remote device 1208 include the server system 200, the payment server 114, the acquirer server 1100 or other computing systems of the issuer server 1200. The communication module 1206 can facilitate such operative communication with the remote devices 1208 and cloud servers using API calls. The communication module 1206 is configured to receive a payment transaction request performed by an account holder (e.g., the cardholder 104(1)) via the network 116. The processing module 1202 receives payment card information, a payment transaction amount, customer information, and merchant information from the remote device 1208 (e.g., the payment server 114). The issuer server 1200 includes a transaction database 1210 for storing transaction data. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular account holder, transaction location information, external data sources, and other internal data to evaluate each transaction. The issuer server 1200 includes a user profile database 1212 storing user profiles associated with the plurality of account holders.

The user profile data may include an account balance, a credit line, details of the account holders, account identification information, payment card number, or the like. The details of the account holders (e.g., the plurality of cardholders 104(1)-104(N)) may include, but are not limited to, name, age, gender, physical attributes, location, registered contact number, family information, alternate contact number, registered e-mail address, or the like of the cardholders 104.

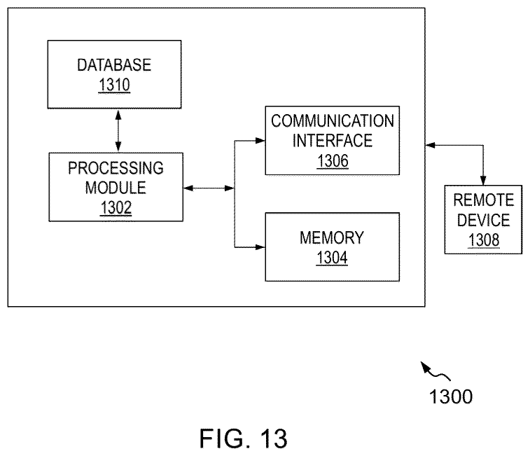

FIG. 13 illustrates a simplified block diagram of the payment server 1300, in accordance with an embodiment of the present disclosure. The payment server 1300 is an example of the payment server 114 of FIG. 1. The payment server 1300 and the server system 200 may use the payment network 112 as a payment interchange network. Examples of payment interchange networks include, but are not limited to, Mastercard® payment system interchange network.

The payment server 1300 includes a processing module 1302 configured to extract programming instructions from a memory 1304 to provide various features of the present disclosure. The components of the payment server 1300 provided herein may not be exhaustive, and the payment server 1300 may include more or fewer components than that depicted in FIG. 13. Further, two or more components may be embodied in one single component, and/or one component may be configured using multiple sub-components to achieve the desired functionalities. Some components of the payment server 1300 may be configured using hardware elements, software elements, firmware elements, and/or a combination thereof.

Via a communication interface 1306, the processing module 1302 receives a request from a remote device 1308, such as the issuer server 110(1), the acquirer server 108(1), or the server system 102. The request may be a request for conducting the payment transaction. The communication may be achieved through API calls, without loss of generality. The payment server 1300 includes a database 1310. The database 1310 also includes transaction processing data such as issuer ID, country code, acquirer ID, and Merchant Identifier (MID), among others.

When the payment server 1300 receives a payment transaction request from the acquirer server 108(1) or a payment terminal (e.g., IoT device), the payment server 1300 may route the payment transaction request to an issuer server (e.g., the issuer server 110(1)). The database 1310 stores transaction identifiers for identifying transaction details such as transaction amount, IoT device details, acquirer account information, transaction records, merchant account information, and the like.

In one example embodiment, the acquirer server 108(1) is configured to send an authorization request message to the payment server 1300. The authorization request message includes, but is not limited to, the payment transaction request.

The processing module 1302 further sends the payment transaction request to the issuer server 110(1) for facilitating the payment transactions from the remote device 1308. The processing module 1302 is further configured to notify the remote device 1308 of the transaction status in the form of an authorization response message via the communication interface 1306. The authorization response message includes, but is not limited to, a payment transaction response received from the issuer server 110(1). Alternatively, in one embodiment, the processing module 1302 is configured to send an authorization response message for declining the payment transaction request, via the communication interface 1306, to the acquirer server 108(1). In one embodiment, the processing module 1302 executes similar operations performed by the server system 200, however, for the sake of brevity, these operations are not explained herein.

The disclosed method with reference to FIGS. 6A and 6B to FIG. 10, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are within the scope of the disclosed technology. Furthermore, any of the software-based embodiments may be uploaded, downloaded, or remotely accessed through a suitable communication means. Such a suitable communication means includes, for example, the Internet, the World Wide Web (WWW), an intranet, software applications, cable (including fiber optic cable), magnetic communications, electromagnetic communications (including RF, microwave, and infrared communications), electronic communications, or other such communication means.

As described earlier, conventional approaches no longer suffice in addressing the dynamic interplay of changing customer demands and evolving business priorities while recommending store locations. Various embodiments of the present disclosure address the critical problem of selecting store locations by generating a set of optimal merchant locations and a set of optimal candidate merchant locations for aggregate merchants involved in the multi-outlet model. Through these embodiments, a robust data-driven solution aimed at understanding the temporal relationship with changing market trends has been described.

The solution of the present disclosure empowers businesses to effectively rank and benchmark store performance against tailored metrics. As would be apparent for the conducted experiment, by applying the methodology of the present disclosure to real-world anonymized and aggregated data from San Francisco's merchant stores, its efficacy in out-of-time evaluation has been assessed such that it surpasses established baseline approaches. This not only reaffirms the adaptability of the proposed approach but also positions it as a valuable tool for brands seeking to optimize their market presence.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause the processor or the computer to perform one or more operations. A computer-readable medium storing, embodying, or encoded with a computer program, or similar language, may be embodied as a tangible data storage device storing one or more software programs that are configured to cause the processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media.

Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable (CD-R), compact disc rewritable (CD-R/W), Digital Versatile Disc (DVD), BLU-RAY® Disc (BD), and semiconductor memories (such as mask ROM, programmable ROM (PROM), (erasable PROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based on these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method comprising:
accessing, by a server system, a transaction feature set, and a social media feature set for each merchant location of a plurality of merchant locations associated with an aggregate merchant from a database associated with the server system;
labeling, by the server system, each merchant location with one of an active merchant flag or an inactive merchant flag based, at least in part, on the transaction feature set;
generating, by the server system, a geospatial merchant graph based, at least in part, on the corresponding transaction feature set, the corresponding social media feature set, and the corresponding label of each merchant location, the geospatial merchant graph comprising a plurality of merchant location nodes corresponding to the plurality of merchant locations, wherein a plurality of edges exist between the plurality of merchant location nodes, each edge indicating information related to a relationship between two distinct merchant location nodes in the geospatial merchant graph;
computing, by a Siamese Machine Learning (ML) model associated with the server system, a merchant-specific embedding for each merchant location in the geospatial merchant graph;
processing, by a Graph Neural Network (GNN) ML model associated with the server system, the geospatial merchant graph to rank each merchant location node of the geospatial merchant graph; and
determining, by the server system, a set of optimal merchant locations from the plurality of merchant locations based, at least in part, on the corresponding rank of each merchant location node.

2. The computer-implemented method as claimed in claim 1, wherein labeling each merchant location is performed using a classification Machine Learning (ML) model.

3. The computer-implemented method as claimed in claim 1, wherein computing the merchant-specific embedding for each merchant location comprises:
performing, by the server system, in a single benchmark merchant location mode:
generating a benchmark merchant location based, at least in part, on a plurality of aggregate merchant criteria; and
computing by the Siamese ML model, the merchant-specific embedding for each merchant location in the geospatial merchant graph based, at least in part, on, the corresponding transaction feature set, the corresponding social media feature set, and the benchmark merchant location.

4. The computer-implemented method as claimed in claim 1, wherein computing the merchant-specific embedding for each merchant location comprises:
performing, by the server system, in a community benchmark merchant location mode:
segregating the plurality of merchant locations into one or more communities using one or more community detection algorithms;
generating a community benchmark merchant location for each community of the one or more communities based, at least in part, on a plurality of aggregate merchant community criteria; and
computing, by the Siamese ML model, the merchant-specific embedding for each merchant location present in an individual community within the geospatial merchant graph based, at least in part, on, the corresponding transaction feature set, the corresponding social media feature set, and the community benchmark merchant location.

5. The computer-implemented method as claimed in claim 1, wherein computing the merchant-specific embedding for each merchant location comprises:
performing, by the server system, in an ideal benchmark merchant location mode:
generating an ideal merchant location based, at least in part, on a plurality of aggregate merchant ideal merchant criteria; and
computing by the Siamese ML model, a merchant-specific embedding for each merchant location in the geospatial merchant graph based, at least in part, on, the corresponding transaction feature set, the corresponding social media feature set, and the ideal merchant location.

6. The computer-implemented method as claimed in claim 1, further comprising:
accessing, by the server system, candidate merchant location information of one or more candidate merchant locations from the aggregate merchant, the candidate merchant location information comprising one or more candidate merchant attributes for each candidate
generating, by the server system, a plurality of candidate merchant location nodes based, at least in part, on the candidate merchant location information;
appending, by the server system, a plurality of candidate merchant location nodes in the geospatial merchant graph based, at least in part, on the candidate merchant location information; and
generating, by the server system, a candidate merchant embedding for each candidate merchant location node based, at least in part on, feature propagation from one or more merchant location nodes present in the neighborhood of each candidate merchant location node in the geospatial merchant graph.

7. The computer-implemented method as claimed in claim 6, wherein generating the plurality of candidate merchant location nodes comprises:
generating, by the server system, a sentiment profile, based at least in part, on the social media feature set;
determining, by the server system, transaction behavior of a plurality of cardholders based on identifying patterns from the transaction feature set; and
generating, by the server system, a plurality of candidate merchant location nodes based, at least in part, on the candidate merchant location information, the sentiment profile, and the transaction behavior.

8. The computer-implemented method as claimed in claim 6, further comprising:
processing, by the GNN ML model, the geospatial merchant graph to rank each merchant location node, and each candidate merchant location node of the geospatial merchant graph; and
determining, by the server system, a set of optimal candidate merchant locations from the one or more candidate merchant locations based, at least in part, on the corresponding rank of each candidate merchant location node.

9. The computer-implemented method as claimed in claim 1, further comprising:
accessing, by the server system, a historical transaction dataset from the database associated with the server system, the historical transaction dataset comprises one or more transaction attributes related to a plurality of payment transactions performed between a plurality of cardholders at a plurality of merchant locations associated with an aggregate merchant;
accessing, by the server system, a social media dataset from the database, the social media dataset comprising one or more social media attributes related to the plurality of merchant locations; and
generating and storing, by the server system, a transaction feature set, and a social media feature set for each merchant location of the plurality of merchant locations in the database based, at least in part, on, the one or more transaction attributes and the one or more social media attributes.

10. The computer-implemented method as claimed in claim 1, wherein the server system is a payment server associated with a payment network.

11. A server system, comprising:
a communication interface;
a memory comprising executable instructions; and
a processor communicably coupled to the communication interface and the memory, the processor configured to cause the server system to at least:
access a transaction feature set, and a social media feature set for each merchant location of a plurality of merchant locations associated with an aggregate merchant from a database associated with the server system;
label each merchant location with one of an active merchant flag or an inactive merchant flag based, at least in part, on the transaction feature set;
generate a geospatial merchant graph based, at least in part, on the corresponding transaction feature set, the corresponding social media feature set, and the corresponding label of each merchant location, the geospatial merchant graph comprising a plurality of merchant location nodes corresponding to the plurality of merchant locations, wherein a plurality of edges exist between the plurality of merchant location nodes, each edge indicating information related to a relationship between two distinct merchant location nodes in the geospatial merchant graph;
compute, by a Siamese Machine Learning (ML) model associated with the server system, a merchant-specific embedding for each merchant location in the geospatial merchant graph;
process, by a Graph Neural Network (GNN) ML model associated with the server system, the geospatial merchant graph to rank each merchant location node of the geospatial merchant graph; and
determine a set of optimal merchant locations from the plurality of merchant locations based, at least in part, on the corresponding rank of each merchant location node.

12. The server system as claimed in claim 11, wherein labeling each merchant location is performed using a classification Machine Learning (ML) model.

13. The server system as claimed in claim 11, wherein to compute the merchant-specific embedding for each merchant location, the server system is further caused, at least in part, to:
perform in a single benchmark merchant location mode:
generating a benchmark merchant location based, at least in part, on a plurality of aggregate merchant criteria; and
computing by the Siamese ML model, the merchant-specific embedding for each merchant location in the geospatial merchant graph based, at least in part, on, the corresponding transaction feature set, the corresponding social media feature set, and the benchmark merchant location.

14. The server system as claimed in claim 11, wherein to compute the merchant-specific embedding for each merchant location, the server system is further caused, at least in part, to:
perform in a community benchmark merchant location mode:
segregating the plurality of merchant locations into one or more communities using one or more community detection algorithms;
generating a community benchmark merchant location for each community of the one or more communities based, at least in part, on a plurality of aggregate merchant community criteria; and
computing, by the Siamese ML model, the merchant-specific embedding for each merchant location present in an individual community within the geospatial merchant graph based, at least in part, on, the corresponding transaction feature set, the corresponding social media feature set, and the community benchmark merchant location.

15. The server system as claimed in claim 11, wherein to compute the merchant-specific embedding for each merchant location, the server system is further caused, at least in part, to:
perform in an ideal benchmark merchant location mode:
generating an ideal merchant location based, at least in part, on a plurality of aggregate merchant ideal merchant criteria; and
computing by the Siamese ML model, a merchant-specific embedding for each merchant location in the geospatial merchant graph based, at least in part, on, the corresponding transaction feature set, the corresponding social media feature set, and the ideal merchant location.

16. The server system as claimed in claim 11, wherein the server system is further caused, at least in part, to:
access candidate merchant location information of one or more candidate merchant locations from the aggregate merchant, the candidate merchant location information comprising one or more candidate merchant attributes for each candidate merchant;
generate a plurality of candidate merchant location nodes based, at least in part, on the candidate merchant location information;
append a plurality of candidate merchant location nodes in the geospatial merchant graph based, at least in part, on the candidate merchant location information; and
generate a candidate merchant embedding for each candidate merchant location node based, at least in part on, feature propagation from one or more merchant location nodes present in the neighborhood of each candidate merchant location node in the geospatial merchant graph.

17. The server system as claimed in claim 16, wherein to generate the plurality of candidate merchant location nodes the server system is further caused, at least in part, to:
generate a sentiment profile, based at least in part, on the social media feature set;
determine transaction behavior of a plurality of cardholders based on identifying patterns from the transaction feature set; and
generate a plurality of candidate merchant location nodes based, at least in part, on the candidate merchant location information, the sentiment profile, and the transaction behavior.

18. The server system as claimed in claim 16, wherein the server system is further caused, at least in part, to:
process, by the GNN ML model, the geospatial merchant graph to rank each merchant location node, and each candidate merchant location node of the geospatial merchant graph; and
determine a set of optimal candidate merchant locations from the one or more candidate merchant locations based, at least in part, on the corresponding rank of each candidate merchant location node.

19. The server system as claimed in claim 11, wherein the server system is further caused, at least in part, to:
access a historical transaction dataset from the database associated with the server system, the historical transaction dataset comprises one or more transaction attributes related to a plurality of payment transactions performed between a plurality of cardholders at a plurality of merchant locations associated with an aggregate merchant;
access a social media dataset from the database, the social media dataset comprising one or more social media attributes related to the plurality of merchant locations; and
generate and store a transaction feature set, and a social media feature set for each merchant location of the plurality of merchant locations in the database based, at least in part, on, the one or more transaction attributes and the one or more social media attributes.

20. A non-transitory computer-readable storage medium comprising computer-executable instructions that, when executed by at least a processor of a server system, cause the server system to perform a method comprising:
accessing a transaction feature set, and a social media feature set for each merchant location of a plurality of merchant locations associated with an aggregate merchant from a database associated with the server system;
labeling each merchant location with one of an active merchant flag or an inactive merchant flag based, at least in part, on the transaction feature set;
generating a geospatial merchant graph based, at least in part, on the corresponding transaction feature set, the corresponding social media feature set, and the corresponding label of each merchant location, the geospatial merchant graph comprising a plurality of merchant location nodes corresponding to the plurality of merchant locations, wherein a plurality of edges exist between the plurality of merchant location nodes, each edge indicating information related to a relationship between two distinct merchant location nodes in the geospatial merchant graph;
computing, by a Siamese Machine Learning (ML) model associated with the server system, a merchant-specific embedding for each merchant location in the geospatial merchant graph;
processing, by a Graph Neural Network (GNN) ML model associated with the server system, the geospatial merchant graph to rank each merchant location node of the geospatial merchant graph; and
determining a set of optimal merchant locations from the plurality of merchant locations based, at least in part, on the corresponding rank of each merchant location node.
